SEQUENCE LISTING (16 sequences)

SEQ ID NO: 1 - DNA, 533 bp, Homo sapiens
tgctcagttcatccctagaggcagctgctccaggaacagaggtgccatgcagccccgggtactccttgttgttgccctcctggcgctcctggcctctgcccgagcttcagaggccgaggatgcctcccttctcagcttcatgcagggttacatgaagcacgccaccaagaccgccaaggatgcactgagcagcgtgcaggagtcccaggtggcccagcaggccaggggctgggtgaccgatggcttcagttccctgaaagactactggagcaccgttaaggacaagttctctgagttctgggatttggaccctgaggtcagaccaacttcagccgtggctgcctgagacctcaataccccaagtccacctgcctatccatcctgcgagctccttgggtcctgcaatctccagggctgcccctgtaggttgcttaaaagggacagtattctcagtgctctcctaccccacctcatgcctggcccccctccaggcatgctggcctcccaataaagctggacaagaagctgctatg

SEQ ID NO: 2 - protein, 99 aa, Homo sapiens
MQPRVLLVVALLALLASARASEAEDASLLSFMQGYMKHATKTAKDALSSVQESQVAQQARGWVTDGFSSLKDYWSTVKDKFSEFWDLDPEVRPTSAVAA

SEQ ID NO: 3 - DNA, 1148 bp, Homo sapiens
tctctctcgcacacatacccacacacacacacacacacacacacgcgcgcgcgaaaacaatatctcatttcttcttcagggagcagctgtgaaggaaatcgggggaggaggatggacacaacatcccatctttgtgtttcgatacagactaagcttttaggccaaccctcctgactggatgggggcggcgggcgtggcatgcatgaaaagtaaacatcagagacctgaagaagcttataaaatagcttgggagaggccagtcaccaagacaggcatctcaaatcggctgattctgcatctggaaactgccttcatcttgaaagaaaagctccaggtcccttctccagccacccagccccaagatggtgatgctgctgctgctgctttccgcactggctggcctcttcggtgcggcagagggacaagcatttcatcttgggaagtgccccaatcctccggtgcaggagaattttgacgtgaataagtatctcggaagatggtacgaaattgagaagatcccaacaacctttgagaatggacgctgcatccaggccaactactcactaatggaaaacggaaagatcaaagtgttaaaccaggagttgagagctgatggaactgtgaatcaaatcgaaggtgaagccaccccagttaacctcacagagcctgccaagctggaagttaagttttcctggtttatgccatcggcaccgtactggatcctggccaccgactatgagaactatgccctcgtgtattcctgtacctgcatcatccaactttttcacgtggattttgcttggatcttggcaagaaaccctaatctccctccagaaacagtggactctctaaaaaatatcctgacttctaataacattgatgtcaagaaaatgacggtcacagaccaggtgaactgccccaagctctcgtaaccaggttctacagggaggctgcacccactccatgttacttctgcttcgctttcccctaccccccccccataaagacaaaccaatcaaccacgacaaaggaagttgacctgaacatgtaaccatgccctaccctgttaccttgctagctgcaaaataaacttgttgctgacctgctgtgctcgcagtagattccaagttaaaaaaaaaaaaaaaaaa

SEQ ID NO: 4 - protein, 189 aa, Homo sapiens
MVMLLLLLSALAGLFGAAEGQAFHLGKCPNPPVQENFDVNKYLGRWYEIEKIPTTFENGRCIQANYSLMENGKIKVLNQELRADGTVNQIEGEATPVNLTEPAKLEVKFSWFMPSAPYWILATDYENYALVYSCTCIIQLFHVDFAWILARNPNLPPETVDSLKNILTSNNIDVKKMTVTDQVNCPKLS

SEQ ID NO: 5 - DNA, 1223 bp, Homo sapiens
gggatccttgagtcctactcagccccagcggaggtgaaggacgtccttccccaggagccgactggccaatcacaggcaggaagatgaaggttctgtgggctgcgttgctggtcacattcctggcaggatgccaggccaaggtggagcaagcggtggagacagagccggagcccgagctgcgccagcagaccgagtggcagagcggccagcgctgggaactggcactgggtcgcttttgggattacctgcgctgggtgcagacactgtctgagcaggtgcaggaggagctgctcagctcccaggtcacccaggaactgagggcgctgatggacgagaccatgaaggagttgaaggcctacaaatcggaactggaggaacaactgaccccggtggcggaggagacgcgggcacggctgtccaaggagctgcaggcggcgcaggcccggctgggcgcggacatggaggacgtgtgcggccgcctggtgcagtaccgcggcgaggtgcaggccatgctcggccagagcaccgaggagctgcgggtgcgcctcgcctcccacctgcgcaagctgcgtaagcggctcctccgcgatgccgatgacctgcagaagcgcctggcagtgtaccaggccggggcccgcgagggcgccgagcgcggcctcagcgccatccgcgagcgcctggggcccctggtggaacagggccgcgtgcgggccgccactgtgggctccctggccggccagccgctacaggagcgggcccaggcctggggcgagcggctgcgcgcgcggatggaggagatgggcagccggacccgcgaccgcctggacgaggtgaaggagcaggtggcggaggtgcgcgccaagctggaggagcaggcccagcagatacgcctgcaggccgaggccttccaggcccgcctcaagagctggttcgagcccctggtggaagacatgcagcgccagtgggccgggctggtggagaaggtgcaggctgccgtgggcaccagcgccgcccctgtgcccagcgacaatcactgaacgccgaagcctgcagccatgcgaccccacgccaccccgtgcctcctgcctccgcgcagcctgcagcgggagaccctgtccccgccccagccgtcctcctggggtggaccctagtttaataaagattcaccaagtttcacgcaaaaaaaaaaaaaaaaaaaaaaaaaaaaaaaaaaaaaaaaaaaa

SEQ ID NO: 6 - protein, 317 aa, Homo sapiens [sequence omitted]

SEQ ID NO: 7 - DNA, 13993 bp, Homo sapiens
atggacccgccgaggcccgcgctgctggcgctgctggcgctgcctgcgctgctgctgctgctgctggcgggcgccagggccgaagaggaaatgctggaaaatgtcagcctggtctgtccaaaagatgcgacccgattcaagcacctccggaagtacacatacaactatgaggctgagagttccagtggagtccctgggactgctgattcaagaagtgccaccaggatcaactgcaaggttgagctggaggttccccagctctgcagcttcatcctgaagaccagccagtgcaccctgaaagaggtgtatggcttcaaccctgagggcaaagccttgctgaagaaaaccaagaactctgaggagtttgctgcagccatgtccaggtatgagctcaagctggccattccagaagggaagcaggttttcctttacccggagaaagatgaacctacttacatcctgaacatcaagaggggcatcatttctgccctcctggttcccccagagacagaagaagccaagcaagtgttgtttctggataccgtgtatggaaactgctccactcactttaccgtcaagacgaggaagggcaatgtggcaacagaaatatccactgaaagagacctggggcagtgtgatcgcttcaagcccatccgcacaggcatcagcccacttgctctcatcaaaggcatgacccgccccttgtcaactctgatcagcagcagccagtcctgtcagtacacactggacgctaagaggaagcatgtggcagaagccatctgcaaggagcaacacctcttcctgcctttctcctacaagaataagtatgggatggtagcacaagtgacacagactttgaaacttgaagacacaccaaagatcaacagccgcttctttggtgaaggtactaagaagatgggcctcgcatttgagagcaccaaatccacatcacctccaaagcaggccgaagctgttttgaagactctccaggaactgaaaaaactaaccatctctgagcaaaatatccagagagctaatctcttcaataagctggttactgagctgagaggcctcagtgatgaagcagtcacatctctcttgccacagctgattgaggtgtccagccccatcactttacaagccttggttcagtgtggacagcctcagtgctccactcacatcctccagtggctgaaacgtgtgcatgccaacccccttctgatagatgtggtcacctacctggtggccctgatccccgagccctcagcacagcagctgcgagagatcttcaacatggcgagggatcagcgcagccgagccaccttgtatgcgctgagccacgcggtcaacaactatcataagacaaaccctacagggacccaggagctgctggacattgctaattacctgatggaacagattcaagatgactgcactggggatgaagattacacctatttgattctgcgggtcattggaaatatgggccaaaccatggagcagttaactccagaactcaagtcttcaatcctgaaatgtgtccaaagtacaaagccatcactgatgatccagaaagctgccatccaggctctgcggaaaatggagcctaaagacaaggaccaggaggttcttcttcagactttccttgatgatgcttctccgggagataagcgactggctgcctatcttatgttgatgaggagtccttcacaggcagatattaacaaaattgtccaaattctaccatgggaacagaatgagcaagtgaagaactttgtggcttcccatattgccaatatcttgaactcagaagaattggatatccaagatctgaaaaagttagtgaaagaagctctgaaagaatctcaacttccaactgtcatggacttcagaaaattctctcggaactatcaactctacaaatctgtttctcttccatcacttgacccagcctcagccaaaatagaagggaatcttatatttgatccaaataactaccttcctaaagaaagcatgctgaaaactaccctcactgcctttggatttgcttcagctgacctcatcgagattggcttggaaggaaaaggctttgagccaacattggaggctccttttgggaagcaaggatttttcccagacagtgtcaacaaagctttgtactgggttaatggtcaagttcctgatggtgtctctaaggtcttagtggaccactttggctataccaaagatgataaacatgagcaggatatggtaaatggaataatgctcagtgttgagaagctgattaaagatttgaaatccaaagaagtcccggaagccagagcctacctccgcatcttgggagaggagcttggttttgccagtctccatgacctccgactcctgggaaagctgcttctgatgggtgcccgcactctgcaggggatcccccagatgattggagaggtcatcaggaagggctcaaagaatgacttttttcttcactacatcttcatggagaatgcctttgaactccccactggagctggattacagttgcaaatatcttcatctggagtcattgctcccggagccaaggctggagtaaaactggaagtagccaacatgcaggctgaactggtggcaaaaccctccgtgtctgtggagtttgtgacaaatatgggcatcatcattccggacttcgctaggagtggggtccagatgaacaccaacttcttccacgagtcgggtctggaggctcatgttgccctaaaagctgggaagctgaagtttatcattccttccccaaagagaccagtcaagctgctcagtggaggcaacacattacatttggtctctaccaccaaaacggaggtcatcccacctctcattgagaacaggcagtcctggtcagtttgcaagcaagtctttcctggcctgaattactgcacctcaggcgcttactccaacgccagctccacagactccgcctcctactatccgctgaccggggacaccagattagagctggaactgaggcctacaggagagattgagcagtattctgtcagcgcaacctatgagctccagagagaggacagagccttggtggataccctgaagtttgtaactcaagcagaaggcgcgaagcagactgaggctaccatgacattcaaatataatcggcagagtatgaccttgtccagtgaagtccaaattccggattttgatgttgacctcggaacaatcctcagagttaatgatgaatctactgagggcaaaacgtcttacagactcaccctggacattcagaacaagaaaattactgaggtcgccctcatgggccacctaagttgtgacacaaaggaagaaagaaaaatcaagggtgttatttccataccccgtttgcaagcagaagccagaagtgagatcctcgcccactggtcgcctgccaaactgcttctccaaatggactcatctgctacagcttatggctccacagtttccaagagggtggcatggcattatgatgaagagaagattgaatttgaatggaacacaggcaccaatgtagataccaaaaaaatgacttccaatttccctgtggatctctccgattatcctaagagcttgcatatgtatgctaatagactcctggatcacagagtccctcaaacagacatgactttccggcacgtgggttccaaattaatagttgcaatgagctcatggcttcagaaggcatctgggagtcttccttatacccagactttgcaagaccacctcaatagcctgaaggagttcaacctccagaacatgggattgccagactcccacatcccagaaaacctcttcttaaaaagcgatggccgcgtcaaatataccttgaacaagaacagtttgaaaattgagattcctttgccttttggtggcaaatcctccagagatctaaagatgttagagactgttaggacaccagccctccacttcaagtctgtgggattccatctgccatctcgagagttccaagtccctacttttaccattcccaagttgtatcaactgcaagtgcctctcctgggtgttctagacctctccacgaatgtctacagcaacttgtacaactggtccgcctcctacagtggtggcaacaccagcacagaccatttcagccttcgggctcgttaccacatgaaggctgactctgtggttgacctgctttcctacaatgtgcaaggatctggagaaacaacatatgaccacaagaatacgttcacactatcatgtgatgggtctctacgccacaaatttctagattcgaatatcaaattcagtcatgtagaaaaacttggaaacaacccagtctcaaaaggtttactaatattcgatgcatctagttcctggggaccacagatgtctgcttcagttcatttggactccaaaaagaaacagcatttgtttgtcaaagaagtcaagattgatgggcagttcagagtctcttcgttctatgctaaaggcacatatggcctgtcttgtcagagggatcctaacactggccggctcaatggagagtccaacctgaggtttaactcctcctacctccaaggcaccaaccagataacaggaagatatgaagatggaaccctctccctcacctccacctctgatctgcaaagtggcatcattaaaaatactgcttccctaaagtatgagaactacgagctgactttaaaatctgacaccaatgggaagtataagaactttgccacttctaacaagatggatatgaccttctctaagcaaaatgcactgctgcgttctgaatatcaggctgattacgagtcattgaggttcttcagcctgctttctggatcactaaattcccatggtcttgagttaaatgctgacatcttaggcactgacaaaattaatagtggtgctcacaaggcgacactaaggattggccaagatggaatatctaccagtgcaacgaccaacttgaagtgtagtctcctggtgctggagaatgagctgaatgcagagcttggcctctctggggcatctatgaaattaacaacaaatggccgcttcagggaacacaatgcaaaattcagtctggatgggaaagccgccctcacagagctatcactgggaagtgcttatcaggccatgattctgggtgtcgacagcaaaaacattttcaacttcaaggtcagtcaagaaggacttaagctctcaaatgacatgatgggctcatatgctgaaatgaaatttgaccacacaaacagtctgaacattgcaggcttatcactggacttctcttcaaaacttgacaacatttacagctctgacaagttttataagcaaactgttaatttacagctacagccctattctctggtaactactttaaacagtgacctgaaatacaatgctctggatctcaccaacaatgggaaactacggctagaacccctgaagctgcatgtggctggtaacctaaaaggagcctaccaaaataatgaaataaaacacatctatgccatctcttctgctgccttatcagcaagctataaagcagacactgttgctaaggttcagggtgtggagtttagccatgggctcaacacagacatcgctgggctggcttcagccattgacatgagcacaaactataattcagactcactgcatttcagcaatgtcttccgttctgtaatggccccgtttaccatgaccatcgatgcacatacaaatggcaatgggaaactcgctctctggggagaacatactgggcagctgtatagcaaattcctgttgaaagcagaacctctggcatttactttctctcatgattacaaaggctccacaagtcatcatctcgtgtctaggaaaagcatcagtgcagctcttgaacacaaagtcagtgccctgcttactccagctgagcagacaggcacctggaaactcaagacccaatttaacaacaatgaatacagccaggacttggatgcttacaacactaaagataaaattggcgtggagcttactggacgaactctggctgacctaactctactagactccccaattaaagtgccacttttactcagtgagcccatcaatatcaatgatgctttagagatgagagatgccgttgagaagccccaagaatttacaattgttgcttttgtaaagtatgataaaaaccaagatgttcactccattaacctcccattttttgagaccttgcaagaatattttgagaggaatcgacaaaccattatagttgtactggaaaacgtacagagaaacctgaagcacatcaatattgatcaatttgtaagaaaatacagagcagccctgggaaaactcccacagcaagctaatgattatctgaattcattcaattgggagagacaagtttcacatgccaaggagaaactgactgctctcacaaaaaagtatagaattacagaaaatgatatacaaattgcattagatgatgccaaaatcaactttaatgaaaaactatctcaactgcagacatatatgatacaatttgatcagtatattaaagatagttatgatttacatgatttgaaaatagctattgctaatattattgatgaaatcattgaaaaattaaaaagtcttgatgagcactatcatacccgtgtaaatttagtaaaaacaatccatgatctacatttgtttattgaaaatattgattttaacaaaagtggaagtagtactgcatcctggattcaaaatgtggatactaagtaccaaatcagaatccagatacaagaaaaactgcagcagcttaagagacacatacagaatatagacatccagcacctagctggaaagttaaaacaacacattgaggctattgatgttagagtgcttttagatcaattgggaactacaatttcatttgaaagaataaatgatgttcttgagcatgtcaaacactttgttataaatcttattggggattttgaagtagctgagaaaatcaatgccttcagagccaaagtccatgagttaatcgagaggtatgaagtagaccaacaaatccaggttttaatggataaattagtagagttggcccaccaatacaagttgaaggagactattcagaagctaagcaatgtcctacaacaagttaagataaaagattactttgagaaattggttggatttattgatgatgctgtcaagaagcttaatgaattatcttttaaaacattcattgaagatgttaacaaattccttgacatgttgataaagaaattaaagtcatttgattaccaccagtttgtagatgaaaccaatgacaaaatccgtgaggtgactcagagactcaatggtgaaattcaggctctggaactaccacaaaaagctgaagcattaaaactgtttttagaggaaaccaaggccacagttgcagtgtatctggaaagcctacaggacaccaaaataaccttaatcatcaattggttacaggaggctttaagttcagcatctttggctcacatgaaggccaaattccgagagactctagaagatacacgagaccgaatgtatcaaatggacattcagcaggaacttcaacgatacctgtctctggtaggccaggtttatagcacacttgtcacctacatttctgattggtggactcttgctgctaagaaccttactgactttgcagagcaatattctatccaagattgggctaaacgtatgaaagcattggtagagcaagggttcactgttcctgaaatcaagaccatccttgggaccatgcctgcctttgaagtcagtcttcaggctcttcagaaagctaccttccagacacctgattttatagtccccctaacagatttgaggattccatcagttcagataaacttcaaagacttaaaaaatataaaaatcccatccaggttttccacaccagaatttaccatccttaacaccttccacattccttcctttacaattgactttgtagaaatgaaagtaaagatcatcagaaccattgaccagatgctgaacagtgagctgcagtggcccgttccagatatatatctcagggatctgaaggtggaggacattcctctagcgagaatcaccctgccagacttccgtttaccagaaatcgcaattccagaattcataatcccaactctcaaccttaatgattttcaagttcctgaccttcacataccagaattccagcttccccacatctcacacacaattgaagtacctacttttggcaagctatacagtattctgaaaatccaatctcctcttttcacattagatgcaaatgctgacatagggaatggaaccacctcagcaaacgaagcaggtatcgcagcttccatcactgccaaaggagagtccaaattagaagttctcaattttgattttcaagcaaatgcacaactctcaaaccctaagattaatccgctggctctgaaggagtcagtgaagttctccagcaagtacctgagaacggagcatgggagtgaaatgctgttttttggaaatgctattgagggaaaatcaaacacagtggcaagtttacacacagaaaaaaatacactggagcttagtaatggagtgattgtcaagataaacaatcagcttaccctggatagcaacactaaatacttccacaaattgaacatccccaaactggacttctctagtcaggctgacctgcgcaacgagatcaagacactgttgaaagctggccacatagcatggacttcttctggaaaagggtcatggaaatgggcctcgcccagattctcagatgagggaacacatgaatcacaaattagtttcaccatagaaggacccctcacttcctttggactgtccaataagatcaatagcaaacacctaagagtaaaccaaaacttggtttatgaatctggctccctcaacttttctaaacttgaaattcaatcacaagtcgattcccagcatgtgggccacagtgttctaactgctaaaggcatggcactgtttggagaagggaaggcagagtttactgggaggcatgatgctcatttaaatggaaaggttattggaactttgaaaaattctcttttcttttcagcccagccatttgagatcacggcatccacaaacaatgaagggaatttgaaagttcgttttccattaaggttaacagggaagatagacttcctgaataactatgcactgtttctgagtcccagtgcccagcaagcaagttggcaagtaagtgctaggttcaatcagtataagtacaaccaaaatttctctgctggaaacaacgagaacattatggaggcccatgtaggaataaatggagaagcaaatctggatttcttaaacattcctttaacaattcctgaaatgcgtctaccttacacaataatcacaactcctccactgaaagatttctctctatgggaaaaaacaggcttgaaggaattcttgaaaacgacaaagcaatcatttgatttaagtgtaaaagctcagtataagaaaaacaaacacaggcattccatcacaaatcctttggctgtgctttgtgagtttatcagtcagagcatcaaatcctttgacaggcattttgaaaaaaacagaaacaatgcattagattttgtcaccaaatcctataatgaaacaaaaattaagtttgataagtacaaagctgaaaaatctcacgacgagctccccaggacctttcaaattcctggatacactgttccagttgtcaatgttgaagtgtctccattcaccatagagatgtcggcattcggctatgtgttcccaaaagcagtcagcatgcctagtttctccatcataggttctgacgtccgtgtgccttcatacacattaatcctgccatcattagagctgccagtccttcatgtccctagaaatctcaagctttctcttccagatttcaaggaattgtgtaccataagccatatttttattcctgccatgggcaatattacctatgatttctcctttaaatcaagtgtcatcacactgaataccaatgctgaactttttaaccagtcagatattgttgctcatctcctttcttcatcttcatctgtcattgatgcactgcagtacaaattagagggcaccacaagattgacaagaaaaaggggattgaagttagccacagctctgtctctgagcaacaaatttgtggagggtagtcataacagtactgtgagcttaaccacgaaaaatatggaagtgtcagtggcaaaaaccacaaaaccggaaattccaattttgagaatgaatttcaagcaagaacttaatggaaataccaagtcaaaacctactgtctcttcctccatggaatttaagtatgatttcaattcttcaatgctgtactctaccgctaaaggagcagttgaccacaagcttagcttggaaagcctcacctcttacttttccattgagtcatctaccaaaggagatgtcaagggttcggttctttctcgggaatattcaggaactattgctagtgaggccaacacttacttgaattccaagagcacacggtcttcagtgaagctgcagggcacttccaaaattgatgatatctggaaccttgaagtaaaagaaaattttgctggagaagccacactccaacgcatatattccctctgggagcacagtacgaaaaaccacttacagctagagggcctctttttcaccaacggagaacatacaagcaaagccaccctggaactctctccatggcaaatgtcagctcttgttcaggtccatgcaagtcagcccagttccttccatgatttccctgaccttggccaggaagtggccctgaatgctaacactaagaaccagaagatcagatggaaaaatgaagtccggattcattctgggtctttccagagccaggtcgagctttccaatgaccaagaaaaggcacaccttgacattgcaggatccttagaaggacacctaaggttcctcaaaaatatcatcctaccagtctatgacaagagcttatgggatttcctaaagctggatgtcaccaccagcattggtaggagacagcatcttcgtgtttcaactgcctttgtgtacaccaaaaaccccaatggctattcattctccatccctgtaaaagttttggctgataaattcattattcctgggctgaaactaaatgatctaaattcagttcttgtcatgcctacgttccatgtcccatttacagatcttcaggttccatcgtgcaaacttgacttcagagaaatacaaatctataagaagctgagaacttcatcatttgccctcaccctaccaacactccccgaggtaaaattccctgaagttgatgtgttaacaaaatattctcaaccagaagactccttgattcccttttttgagataaccgtgcctgaatctcagttaactgtgtcccagttcacgcttccaaaaagtgtttcagatggcattgctgctttggatctaaatgcagtagccaacaagatcgcagactttgagttgcccaccatcatcgtgcctgagcagaccattgagattccctccattaagttctctgtacctgctggaattgtcattccttcctttcaagcactgactgcacgctttgaggtagactctcccgtgtataatgccacttggagtgccagtttgaaaaacaaagcagattatgttgaaacagtcctggattccacatgcagctcaaccgtacagttcctagaatatgaactaaatgttttgggaacacacaaaatcgaagatggtacgttagcctctaagactaaaggaacacttgcacaccgtgacttcagtgcagaatatgaagaagatggcaaatatgaaggacttcaggaatgggaaggaaaagcgcacctcaatatcaaaagcccagcgttcaccgatctccatctgcgctaccagaaagacaagaaaggcatctccacctcagcagcctccccagccgtaggcaccgtgggcatggatatggatgaagatgacgacttttctaaatggaacttctactacagccctcagtcctctccagataaaaaactcaccatattcaaaactgagttgagggtccgggaatctgatgaggaaactcagatcaaagttaattgggaagaagaggcagcttctggcttgctaacctctctgaaagacaacgtgcccaaggccacaggggtcctttatgattatgtcaacaagtaccactgggaacacacagggctcaccctgagagaagtgtcttcaaagctgagaagaaatctgcagaacaatgctgagtgggtttatcaaggggccattaggcaaattgatgatatcgacgtgaggttccagaaagcagccagtggcaccactgggacctaccaagagtggaaggacaaggcccagaatctgtaccaggaactgttgactcaggaaggccaagccagtttccagggactcaaggataacgtgtttgatggcttggtacgagttactcaaaaattccatatgaaagtcaagaagctgattgactcactcattgattttctgaacttccccagattccagtttccggggaaacctgggatatacactagggaggaactttgcactatgttcatgagggaggtagggacggtactgtcccaggtatattcgaaagtccataatggttcagaaatactgttttcctatttccaagacctagtgattacacttcctttcgagttaaggaaacataaactaatagatgtaatctcgatgtatagggaactgttgaaagatttatcaaaagaagcccaagaggtatttaaagccattcagtctctcaagaccacagaggtgctacgtaatcttcaggaccttttacaattcattttccaactaatagaagataacattaaacagctgaaagagatgaaatttacttatcttattaattatatccaagatgagatcaacacaatcttcaatgattatatcccatatgtttttaaattgttgaaagaaaacctatgccttaatcttcataagttcaatgaatttattcaaaacgagcttcaggaagcttctcaagagttacagcagatccatcaatacattatggcccttcgtgaagaatattttgatccaagtatagttggctggacagtgaaatattatgaacttgaagaaaagatagtcagtctgatcaagaacctgttagttgctcttaaggacttccattctgaatatattgtcagtgcctctaactttacttcccaactctcaagtcaagttgagcaatttctgcacagaaatattcaggaatatcttagcatccttaccgatccagatggaaaagggaaagagaagattgcagagctttctgccactgctcaggaaataattaaaagccaggccattgcgacgaagaaaataatttctgattaccaccagcagtttagatataaactgcaagatttttcagaccaactctctgattactatgaaaaatttattgctgaatccaaaagattgattgacctgtccattcaaaactaccacacatttctgatatacatcacggagttactgaaaaagctgcaatcaaccacagtcatgaacccctacatgaagcttgctccaggagaacttactatcatcctctaatttttttaaaagaaatcttcatttattcttcttttccaattgaactttcacatagcacagaaaaaattcaaactgcctatattgataaaaccatacagtgagccagccttgcagtaggcagtagactataagcagaagcacatatgaactggacctgcaccaaagctggcaccagggctcggaaggtctctgaactcagaaggatggcattttttgcaagttaaagaaaatcaggatctgagttattttgctaaacttgggggaggaggaacaaataaatggagtctttattgtgtatcat

SEQ ID NO: 8 - protein, 4563 aa, Homo sapiens [sequence omitted]

SEQ ID NO: 9 - DNA, 473 bp, Homo sapiens
aggcacagacaccaaggacagagacgctggctaggccgccctccccactgttaccaacatgaagctgctcgcagcaactgtgctactcctcaccatctgcagccttgaaggagctttggttcggagacaggcaaaggagccatgtgtggagagcctggtttctcagtacttccagaccgtgactgactatggcaaggacctgatggagaaggtcaagagcccagagcttcaggccgaggccaagtcttactttgaaaagtcaaaggagcagctgacacccctgatcaagaaggctggaacggaactggttaacttcttgagctatttcgtggaacttggaacacagcctgccacccagtgaagtgtccagaccattgtcttccaaccccagctggcctctagaacacccactggccagtcctagagctcctgtccctacccactctttgctacaataaatgctgaatgaatcc

SEQ ID NO: 10 - protein, 100 aa, Homo sapiens
MKLLAATVLLLTICSLEGALVRRQAKEPCVESLVSQYFQTVTDYGKDLMEKVKSPELQAEAKSYFEKSKEQLTPLIKKAGTELVNFLSYFVELGTQPATQ

SEQ ID NO: 11 - DNA, 897 bp, Homo sapiens
agagactgcgagaaggaggtcccccacggcccttcaggatgaaagctgcggtgctgaccttggccgtgctcttcctgacggggagccaggctcggcatttctggcagcaagatgaacccccccagagcccctgggatcgagtgaaggacctggccactgtgtacgtggatgtgctcaaagacagcggcagagactatgtgtcccagtttgaaggctccgccttgggaaaacagctaaacctaaagctccttgacaactgggacagcgtgacctccaccttcagcaagctgcgcgaacagctcggccctgtgacccaggagttctgggataacctggaaaaggagacagagggcctgaggcaggagatgagcaaggatctggaggaggtgaaggccaaggtgcagccctacctggacgacttccagaagaagtggcaggaggagatggagctctaccgccagaaggtggagccgctgcgcgcagagctccaagagggcgcgcgccagaagctgcacgagctgcaagagaagctgagcccactgggcgaggagatgcgcgaccgcgcgcgcgcccatgtggacgcgctgcgcacgcatctggccccctacagcgacgagctgcgccagcgcttggccgcgcgccttgaggctctcaaggagaacggcggcgccagactggccgagtaccacgccaaggccaccgagcatctgagcacgctcagcgagaaggccaagcccgcgctcgaggacctccgccaaggcctgctgcccgtgctggagagcttcaaggtcagcttcctgagcgctctcgaggagtacactaagaagctcaacacccagtgaggcgcccgccgccgccccccttcccggtgctcagaataaacgtttccaaagtggg

SEQ ID NO: 12 - protein, 267 aa, Homo sapiens
MKAAVLTLAVLFLTGSQARHFWQQDEPPQSPWDRVKDLATVYVDVLKDSGRDYVSQFEGSALGKQLNLKLLDNWDSVTSTFSKLREQLGPVTQEFWDNLEKETEGLRQEMSKDLEEVKAKVQPYLDDFQKKWQEEMELYRQKVEPLRAELQEGARQKLHELQEKLSPLGEEMRDRARAHVDALRTHLAPYSDELRQRLAARLEALKENGGARLAEYHAKATEHLSTLSEKAKPALEDLRQGLLPVLESFKVSFLSALEEYTKKLNTQ

SEQ ID NO: 13 - DNA, 419 bp, Homo sapiens
cccgcagctcagccacggcacagatcagcaccacgacccctccctcgggcctcgccatgaggctcttcctgtcgctcccggtcctggtggtggttctgtcgatcgtcttggaaggcccagccccagcccaggggaccccagacgtctccagtgccttggataagctgaaggagtttggaaacacactggaggacaaggctcgggaactcatcagccgcatcaaacagagtgaactttctgccaagatgcgggagtggttttcagagacatttcagaaagtgaaggagaaactcaagattgactcatgaggacctgaagggtgacatccaggaggggcctctgaaatttcccacaccccagcgcctgtgctgaggactcccgccatgtggccccaggtgccaccaataaaaatcctaccg

SEQ ID NO: 14 - protein, 83 aa, Homo sapiens
MRLFLSLPVLVVVLSIVLEGPAPAQGTPDVSSALDKLKEFGNTLEDKARELISRIKQSELSAKMREWFSETFQKVKEKLKIDS

SEQ ID NO: 15 - DNA, 444 bp, Homo sapiens
atgggcacacgactcctcccagctctgtttcttgtcctcctggtattgggatttgaggtccaggggacccaacagccccagcaagatgagatgcctagcccgaccttcctcacccaggtgaaggaatctctctccagttactgggagtcagcaaagacagccgcccagaacctgtacgagaagacatacctgcccgctgtagatgagaaactcagggacttgtacagcaaaagcacagcagccatgagcacttacacaggcatttttactgaccaagttctttctgtgctgaagggagaggagtaacagccagaccccccatcagtggacaaggggagagtcccctactcccctgatcccccaggttcagactgagctcccccttcccagtagctcttgcatcctcctcccaactctagcctgaattcttttcaataaaaaata

SEQ ID NO: 16 - protein, 101 aa, Homo sapiens
MGTRLLPALFLVLLVLGFEVQGTQQPQQDEMPSPTFLTQVKESLSSYWESAKTAAQNLYEKTYLPAVDEKLRDLYSKSTAAMSTYTGIFTDQVLSVLKGEE

(19) United States
(12) Patent Application Publication
(10) Pub. No.: US 2014/0303902 A1
(43) Pub. Date: Oct. 9, 2014

(54) Methods, System, and Medium for Associating Rheumatoid Arthritis Subjects with Cardiovascular Disease

(71) Applicants: OKLAHOMA MEDICAL RESEARCH FOUNDATION, OKLAHOMA CITY, OK (US); The Johns Hopkins University, Baltimore (MD)

(72) Inventors: Petar Alaupovic, Oklahoma City, OK (US); Michael Centola, Oklahoma City, OK (US); Joan Bathon, Baltimore, MD (US); Jon Giles, Dundlak, MD (US); Nicholas Knowlton, Choctaw, OK (US); Adam Joshua Payne, Oklahoma City, OK (US)

(21) Appl. No.: 14/316,654

(22) Filed: Jun. 26, 2014

Related U.S. Application Data
(63) Continuation of application No. 13/262,767, filed on Jan. 20, 2012.
(60) Provisional application No. 61/252,447, filed on Oct. 16, 2009.
(60) Provisional application No. 61/166,517, filed on Apr. 3, 2009.

(51) Int. Cl. G06F 19/00

(52) U.S. Cl. CPC G06F 19/3431
USPC 702/19

(57) ABSTRACT

The present invention relates to a system and a medium for analyzing one or more analytes in rheumatoid arthritis subjects to determine whether the subject is at increased risk of diseases such as a cardiovascular disease, the subject's current cardiovascular disease burden, and the likelihood of cardiovascular disease progression in the subject. In addition, the present invention further provides methods for analyzing data to determine risk of cardiovascular disease, current cardiovascular disease burden, and the likelihood of cardiovascular disease progression in a rheumatoid arthritis subject.

### CROSS REFERENCE TO RELATED APPLICATIONS

This application is a continuation of U.S. patent application Ser. No. 13/262,767, filed Apr. 5, 2010 (pending), which is a National Stage of International Application No. PCT/US2010/029982, filed Apr. 5, 2010, which claims the benefit of U.S. Provisional Application No. 61/166,517 filed Apr. 3, 2009, and U.S. Provisional Application No. 61/252,447 filed Oct. 16, 2009, the disclosures of which are incorporated by reference for all purposes.

### STATEMENT REGARDING FEDERALLY SPONSORED RESEARCH OR DEVELOPMENT

Not applicable.

### SEQUENCE LISTING

The instant application contains a Sequence Listing which has been submitted via EFS-Web and is hereby incorporated by reference in its entirety. Said ASCII copy, created on Jun. 26, 2014, is named 27078_US_sequencelisting.txt, and is 77,824 bytes in size.

### BACKGROUND OF THE INVENTION

1. Field of the Invention

The invention relates to methods, systems, and media for determining the risk of cardiovascular disease in RA subjects.

2. Description of the Related Art

Rheumatoid arthritis (RA) is a chronic systemic inflammatory disease characterized by progressive joint deformity and disability affecting approximately 2.1 million adult Americans (1). Numerous recent studies have shown a close association between RA and cardiovascular disease (CVD) (2-6). It has been estimated that one third to one half of RA-related deaths are due to CVD (3, 4, 7) and its underlying atherosclerosis. Evidence suggests that atherosclerosis is an inflammatory disorder with pathogenic features overlapping with those characterizing synovial inflammation of RA subjects (3, 8, 9), which may contribute to excess atherosclerosis in RA subjects. The pathogenic features common to both atherosclerosis and RA include pro-inflammatory cytokines, elevated levels of acute phase reactants, neo-angiogenesis, T-cell activation, and leukocyte adhesion molecules, as well as endothelial cell injury (3, 8-10). In addition, recent findings regarding the metabolic and clinical significance of apolipoproteins (apo), the protein components of plasma lipoproteins, have provided new insights into their role(s) in atherogenesis and its clinical consequences, and indicate that these roles of apolipoproteins are not in conflict with other inflammatory-driven processes. Studies from this and other laboratories have been specifically focusing on the metabolic properties and atherogenic capacity of apolipoprotein C-III (apoC-III) (11-23). Increased concentrations of apoC-III have been shown to inhibit lipoprotein lipase activity (12) and to interfere with binding of apolipoprotein B (apoB)-containing lipoproteins to hepatic lipoprotein receptors (13). Furthermore, it has been established that apoC-III bound to apoB-containing lipoproteins is an independent risk factor of atherosclerosis and a significant contributor to the progression of atherosclerotic lesions (15-23). The clinical significance of apoC-Ill has been further strengthened by recent studies showing its role in inflammatory process as the activator of monocytic and endothelial cells (24-26). It has also been demonstrated that the adherence of activated monocytic cells to endothelial cells only occurs via apoC-III bound to apoB-containing lipoproteins. According to the nontraditional classification of plasma lipoproteins based on apolipoprotein composition rather than density properties, there are five major apoB-containing lipoproteins, referred to as LpB, LpB:E, LpB:C, LpB:C:E and LpA-II:B:C:D:E (27-29), where “A-II,” “B,” “C,” “D” and “E” refer to apolipoprotein A-II, apolipoprotein B, apolipoprotein C, apolipoprotein D, and apolipoprotein E, respectively. The atherogenic capacity of LpB:C particles may be greater than those of LpB:C:E and LpA-II:B:C:D:E particles (22, 30, 31).

The present teachings provide methods, systems, and media for analyzing the levels of lipid and lipoprotein analytes in RA subjects, which permits the determination of risk, diagnosis, detection, and monitoring of CVD, e.g. atherosclerosis, in RA subjects, and the determination of atherosclerosis burden. These in turn allow for improved treatment of RA subjects with or at risk for CVD.

### SUMMARY OF THE INVENTION

Disclosed herein is a computer-implemented method for determining whether a rheumatoid arthritis subject is at risk for a cardiovascular disease (CVD) comprising: storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; storing, in a storage memory, a second dataset, wherein the second dataset comprises data indicating a predetermined threshold level of the at least one marker, wherein the threshold level is determined from a database comprising data associated with a plurality of subjects clinically diagnosed with RA and known to be progressors for atherosclerosis; comparing, by a computer processor, the level of the at least one marker of the first dataset with the threshold level of the at least one marker of the second dataset; and determining that the subject is at risk of CVD progression when the level of the at least one marker of the first dataset is elevated above the threshold level of the at least one marker of the second dataset.

In one embodiment, the CVD is atherosclerosis.

In one embodiment, the determination of whether the plurality of subjects are progressors for atherosclerosis is based on a positive change in the coronary artery calcium (CAC) measurements of each of the plurality of subjects at two timepoints approximately 2 to 4 years apart.

Also disclosed herein is a computer-implemented method for determining whether a rheumatoid arthritis subject is at risk for a cardiovascular disease (CVD) comprising: storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; determining, by a computer processor, a first CVD risk score from the first dataset using an interpretation function, wherein the first CVD risk score provides a quantitative measure of CVD risk in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from the group consisting of: age, whether the subject is on prednisone, whether the subject is on plaquenial, whether the subject is on a DMARD such as, e.g., methotrexate, whether the subject is on a biologic, hypertension, and whether the subject is on a statin.

In one embodiment, the CVD is atherosclerosis.

In one embodiment, the predictive model is predictive of a positive change in the coronary artery calcium (CAC) measurement of the subject.

Also disclosed is a computer-implemented method for determining whether a rheumatoid arthritis subject is at risk for atherosclerosis progression comprising: storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; storing, in a storage memory, a second dataset, wherein the second dataset comprises data indicating a predetermined threshold level of the at least one marker, wherein the threshold level is determined from a database comprising data associated with a plurality of subjects clinically diagnosed with RA and known to be progressors for atherosclerosis; comparing, by a computer processor, the level of the at least one marker of the first dataset with the threshold level of the at least one marker of the second dataset; and determining that the subject is at risk of atherosclerosis progression when the level of the at least one marker of the first dataset is elevated above the threshold level of the at least one marker of the second dataset.

Also disclosed is a computer-implemented method for determining whether a rheumatoid arthritis subject is at risk for atherosclerosis progression comprising: storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; determining, by a computer processor, a first atherosclerosis progression risk score from the first dataset using an interpretation function, wherein the first atherosclerosis progression risk score provides a quantitative measure of atherosclerosis progression risk in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from group consisting of: age, whether the subject is on prednisone, whether the subject is on plaquenial, whether the subject is on DMARD such as, e.g., methotrexate, whether the subject is on a biologic, hypertension, and whether the subject is on a statin.

Also disclosed is a computer-implemented method for determining an atherosclerosis burden in an RA subject comprising: storing, in a storage memory, a first dataset associated with a sample obtained from the subject, wherein the first dataset comprises data indicating the level of at least one marker selected from the group consisting of HDL-cholesterol, LpA-I, triglyceride, apoB, VLDL-C, LpA-II:B:C:D:E, LpB:C, LpB, LpB:E+LpB:C:E, apoA-I, and LpA-I:A-II; storing, in a storage memory, a second dataset, wherein the second dataset comprises data indicating a predetermined threshold level of the at least one marker, wherein the threshold level is determined from a database comprising data associated with a plurality of subjects clinically diagnosed with RA and of a known atherosclerosis burden; comparing, by a computer processor, the level of the at least one marker of the first dataset with the threshold level of the at least one marker of the second dataset; and determining the level of the atherosclerosis burden in the RA subject when the level of the at least one marker of the first dataset is elevated above the threshold level of the at least one marker of the second dataset.

In one embodiment, the at least one marker comprises LpB:C, apoB, LpA-II:B:C:D:E, LpB, LpB:E+LpB:C:E, apoA-I, LpA-I, or LpA-I:A-II.

In one embodiment, the atherosclerosis burden of the plurality of subjects is based on a carotid artery IMT measurement of each of the plurality of subjects.

Also disclosed is a computer-implemented method for determining an atherosclerosis burden in an RA subject comprising: storing, in a storage memory, a first dataset associated with a sample obtained from the subject, wherein the first dataset comprises data indicating the level of at least one marker selected from the group consisting of LpB:C, apoB, LpA-II:B:C:D:E, LpB, LpB:E+LpB:C:E, apoA-I, LpA-I, and LpA-I:A-II; determining, by a computer processor, a first atherosclerosis burden score from the first dataset using an interpretation function, wherein the first atherosclerosis burden score provides a quantitative indication of atherosclerosis burden in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from group consisting of: age, whether the subject is on prednisone, whether the subject is on plaquenial, whether the subject is on DMARD such as, e.g., methotrexate, whether the subject is on a biologichypertension, and whether the subject is on a statin.

In one embodiment the method further comprises selecting a CVD treatment regimen based on the determination of whether the subject is at risk for a CVD.

In one embodiment the method further comprises: storing, in a storage memory, a third dataset associated with a second sample obtained from the subject, wherein the first sample and the second sample are obtained from the subject at different times; comparing, by a computer processor, the level of the at least one marker of the first dataset with the level of the at least one marker of the third dataset to determine a change in the levels, wherein the change indicates a change in the atherosclerosis burden in the subject.

In one embodiment the method further comprises: administering a treatment to the subject to reduce the atherosclerosis burden; storing, in a storage memory, a third dataset associated with a second sample obtained from the subject, wherein the first sample and the second sample are obtained from the subject at different times, and wherein the second sample is obtained from the subject after the treatment is administered to the subject; comparing, by a computer processor, the level of the at least one marker of the first dataset with the level of the at least one marker of the third dataset to determine a change in the levels, wherein the change indicates a change in the atherosclerosis burden in the subject; and determining the efficacy of the treatment to reduce the atherosclerosis burden in the RA subject based on the change in the levels.

In one embodiment the method further comprises: administering a treatment to the subject to reduce risk of CVD; storing, in a storage memory, a third dataset associated with a second sample obtained from the subject, wherein the first sample and the second sample are obtained from the subject at different times, and wherein the second sample is obtained from the subject after the treatment is administered to the subject; comparing, by a computer processor, the level of the at least one marker of the first dataset with the level of the at least one marker of the third dataset to determine a change in the levels, wherein the change indicates a change in CVD risk in the subject; and determining the efficacy of treatment to reduce risk of CVD in the RA subject based on the change in the levels.

Also disclosed is a system for determining whether a rheumatoid arthritis subject is at risk for a cardiovascular disease (CVD), the system comprising: a first storage memory for storing a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; a second storage memory for storing a second dataset, wherein the second dataset comprises data indicating a predetermined threshold level of the at least one marker, wherein the threshold level is determined from a database comprising data associated with a plurality of subjects clinically diagnosed with RA and known to be progressors for atherosclerosis; and a computer processor, communicatively coupled to the first and second storage memories, for determining that the subject is at risk of CVD progression by comparing the level of the at least one marker of the first dataset with the threshold level of the at least one marker of the second dataset, and determining that the subject is at risk of CVD progression when the level of the at least one marker of the first dataset is elevated above the threshold level of the at least one marker of the second dataset.

In one embodiment, the CVD is atherosclerosis.

In one embodiment, the determination of whether the plurality of subjects are progressors for atherosclerosis is based on a positive change in the coronary artery calcium (CAC) measurements of each of the plurality of subjects at two timepoints approximately 2 to 4 years apart.

Also disclosed is a system for determining whether a rheumatoid arthritis subject is at risk for a cardiovascular disease (CVD), the system comprising: a storage memory for storing a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; and a computer processor, communicatively coupled to the storage memory, for determining a first CVD risk score from the first dataset using an interpretation function, wherein the first CVD risk score provides a quantitative measure of CVD risk in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from the group consisting of: age, whether the subject is on prednisone, whether the subject is on plaquenial, whether the subject is on a DMARD such as, e.g., methotrexate, whether the subject is on a biologic, hypertension, and whether the subject is on a statin.

In one embodiment, the CVD is atheroclerosis.

In one embodiment, the predictive model is predictive of a positive change in the coronary artery calcium (CAC) measurement of the subject.

Also disclosed is a system for determining whether a rheumatoid arthritis subject is at risk for atherosclerosis progression, the system comprising: a first storage memory for storing a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; a second storage memory for storing a second dataset, wherein the second dataset comprises data indicating a predetermined threshold level of the at least one marker, wherein the threshold level is determined from a database comprising data associated with a plurality of subjects clinically diagnosed with RA and known to be progressors for atherosclerosis; a computer processor, communicatively coupled to the first and second storage memories, for determining that the subject is a risk of atherosclerosis by comparing the level of the at least one marker of the first dataset with the threshold level of the at least one marker of the second dataset, and determining that the subject is at risk of atherosclerosis progression when the level of the at least one marker of the first dataset is elevated above the threshold level of the at least one marker of the second dataset.

Also disclosed is a system for determining whether a rheumatoid arthritis subject is at risk for atherosclerosis progression comprising: a storage memory for storing a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C; and a computer processor communicatively coupled to the storage memory for determining a first atherosclerosis progression risk score from the first dataset using an interpretation function, wherein the first atherosclerosis progression risk score provides a quantitative measure of atherosclerosis progression risk in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from group consisting of: age, whether the subject is on prednisone, whether the subject is on plaquenial, whether the subject is on DMARD such as, e.g., methotrexate, whether the subject is on a biologic, hypertension, and whether the subject is on a statin.

Also disclosed is a system for determining an atherosclerosis burden in an RA subject comprising: a first storage memory for storing a first dataset associated with a sample obtained from the subject, wherein the first dataset comprises data indicating the level of at least one marker selected from the group consisting of HDL-cholesterol, LpA-I, triglyceride, apoB, VLDL-cholesterol, LpA-II:B:C:D:E, LpB:C, LpB, LpB:E+LpB:C:E, apoA-1, and LpA-I:A-II; a second storage memory for storing a second dataset, wherein the second dataset comprises data indicating a predetermined threshold level of the at least one marker, wherein the threshold level is determined from a database comprising data associated with a plurality of subjects clinically diagnosed with RA and of a known atherosclerosis burden; and a computer processor, communicatively coupled to the first and second storage memories, for determining the level of the atherosclerosis burden in the RA subject by comparing the level of the at least one marker of the first dataset with the threshold level of the at least one marker of the second dataset, and determining the level of the atherosclerosis burden in the RA subject when the level of the at least one marker of the first dataset is elevated above the threshold level of the at least one marker of the second dataset.

In one embodiment, the at least one marker comprises LpB:C, apoB, LpA-II:B:C:D:E, LpB, LpB:E+LpB:C:E, apoA-I, LpA-I, or LpA-I:A-II.

In one embodiment, the atherosclerosis burden of the plurality of subjects is based on a carotid artery IMT measurement of each of the plurality of subjects.

Also disclosed is a system for determining an atherosclerosis burden in an RA subject comprising: a storage memory for storing a first dataset associated with a sample obtained from the subject, wherein the first dataset comprises data indicating the level of at least one marker selected from the group consisting of HDL-cholesterol, LpA-I, triglyceride, apoB, VLDL-cholesterol, LpA-II:B:C:D:E, LpB:C, LpB, LpB:E+LpB:C:E, apoA-1, and LpA-I:A-II; and a computer processor communicatively coupled to the storage memory for determining a first atherosclerosis burden score from the first dataset using an interpretation function, wherein the first atherosclerosis burden score provides a quantitative indication of atherosclerosis burden in the subject.

In one embodiment, the interpretation function is based on a predictive model.

In one embodiment, the dataset further comprises one or more clinical assessments, one or more clinical parameters, or a combination of one or more clinical assessments and one or more clinical parameters.

In one embodiment, the one or more clinical assessments comprise the Framingham Cardiac Risk Score.

In one embodiment, the one or more clinical parameters is selected from group consisting of: age, whether the subject is on prednisone, whether the subject is on plaquenial, whether the subject is on DMARD such as, e.g., methotrexate, whether the subject is on a biologic, hypertension, and whether the subject is on a statin.

In one embodiment, the system further comprises selecting a CVD treatment regimen based on the determination of whether the subject is at risk for a CVD.

In one embodiment, the system further comprises: a third storage memory for storing a third dataset associated with a second sample obtained from the subject, wherein the first sample and the second sample are obtained from the subject at different times; and a computer processor, communicatively coupled to the first, second and third storage memories, for determining a change in the atherosclerosis burden in the subject by comparing the level of the at least one marker of the first dataset with the level of the at least one marker of the third dataset to determine a change in the levels, wherein the change indicates a change in the atherosclerosis burden in the subject.

In one embodiment, the system further comprises: administering a treatment to the subject to reduce the atherosclerosis burden; a third storage memory for storing a third dataset associated with a second sample obtained from the subject, wherein the first sample and the second sample are obtained from the subject at different times, and wherein the second sample is obtained from the subject after the treatment is administered to the subject; and a computer processor, communicatively coupled to the first, second and third storage memories, for determining the efficacy of the treatment to reduce the atherosclerosis burden in the subject, by comparing the level of the at least one marker of the first dataset with the level of the at least one marker of the third dataset to determine a change in the levels, wherein the change indicates a change in the atherosclerosis burden in the subject, wherein the change in the atherosclerosis burden in the subject indicates the efficacy of the treatment to reduce the atherosclerosis burden in the RA subject.

In one embodiment, the system further comprises: administering a treatment to the subject to reduce risk of CVD; a third storage memory for storing a third dataset associated with a second sample obtained from the subject, wherein the first sample and the second sample are obtained from the subject at different times, and wherein the second sample is obtained from the subject after the treatment is administered to the subject; and a computer processor, communicatively coupled to the first, second and third storage memories, for determining the efficacy of treatment to reduce risk of CVD in the subject by comparing the level of the at least one marker of the first dataset with the level of the at least one marker of the third dataset to determine a change in the levels, wherein the change indicates a change in CVD risk in the subject, and wherein the change in CVD risk indicates the efficacy of the treatment to reduce risk of CVD in the subject.

### BRIEF DESCRIPTION OF THE SEVERAL VIEWS OF THE DRAWINGS

These and other features, aspects, and advantages of the present invention will become better understood with regard to the following description, and accompanying drawings, where:

FIG. 1 shows the relationship of individual apoA- and apoB-containing lipoprotein families defined by their unique apolipoprotein composition to major lipoprotein density classes against the density gradient background (d=0.92-d=1.25 g/mL). The lines under lipoprotein families designate the approximate density boundaries with solid lines depicting the actual and with broken lines the possible localization of each lipoprotein family. Each of the lipoprotein families represents polydisperse systems of particles, each of which has a different lipid/protein ratio but the same qualitative apolipoprotein composition. The polydisperse character of each lipoprotein family is the main reason for their overlap within certain density segments. Abbreviations: Chylos=chylomicrons, VLDL very low density lipoproteins, IDL=intermediate density lipoproteins, LDL=low density lipoproteins, HDL=high density lipoproteins, VHDL=very high density lipoproteins, HDL₂=high density lipoprotein subfractions with d=1.064-1.125 g/mL, HDL₃=high density subfraction with d=1.125-1.21 g/mL, apo=apolipoprotein, LpB=lipoprotein B characterized by apoB as the sole protein constituent, LpB:C=lipoprotein B:C characterized by apoB and apoC as protein constituents, LpA-I=lipoprotein A-I characterized by apoA-I as the protein constituent, LpB:E=lipoprotein B:E characterized by apoB and apoE as protein constituents, LpA-I:A-II=lipoprotein A-I:A-II characterized by apoA-I and apoA-II as protein constituents, LpA-II=lipoprotein A-II characterized by apoA-II as the protein constituent, LpB:C:E=lipoprotein B:C:E characterized by apoB, apoC, and apoE as protein constituents, LpA-II:B:C:D:E=lipoprotein A-II:B:C:D:E characterized by apoA-II, apoB, apoC, apoD, and apoE as protein constituents.

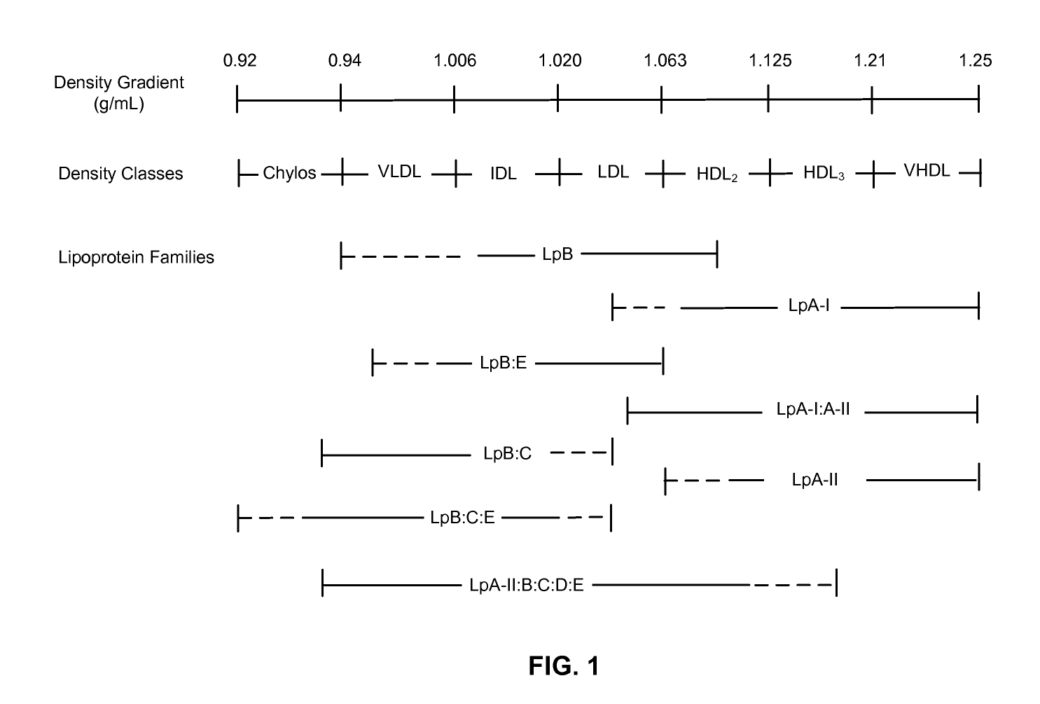

FIG. 2 shows the correlation of atherosclerosis burden predicted by a multivariate model with observed burden. See Example 2. A Boosted Tree Model was used, with common carotid artery IMT measurements as the surrogate endpoint for atherosclerosis burden. The model was first trained on a dataset of 102 individuals, with a correlation of 0.74 (predicted burden by multivariate parameters to observed burden by IMT). A naive test set of 43 individuals was then tested, with a correlation of 0.44.

FIG. 3 is a data flow diagram illustrating a computer-implemented method according to one embodiment.

### DETAILED DESCRIPTION OF THE INVENTION

### Definitions

Terms used in the claims and specification are defined as set forth below unless otherwise specified.

The term “analyte” in the context of the present teachings can mean any substance to be measured, and can encompass biomarkers, markers, electrolytes and elements.

The term “antibody” refers to any immunoglobulin-like molecule that reversibly binds to another with the required selectivity. Thus, the term includes any such molecule that is capable of selectively binding to a marker of the invention. The term includes an immunoglobulin molecule capable of binding an epitope present on an antigen. The term is intended to encompasses not only intact immunoglobulin molecules such as monoclonal and polyclonal antibodies, but also bi-specific antibodies, humanized antibodies, chimeric antibodies, anti-idiopathic (anti-ID) antibodies, single-chain antibodies, Fab fragments, F(ab′) fragments, fusion proteins antibody fragment, immunoglobulin fragment, Fᵥ, single chain (sc) Fᵥ, and chimeras comprising an immunoglobulin sequence and any modifications of the foregoing that comprise an antigen recognition site of the required selectivity.

To “associate” includes determining a set of analyte values by measurement of analyte levels in a sample or receipt of data reflecting such measurement and comparing the levels against analyte levels in a sample or set of samples from the same subject or other subject(s).

The terms “biomarker,” “biomarkers,” “marker” or “markers” in the context of the present teachings encompass, without limitation, lipids, lipoproteins, proteins, cytokines, chemokines, growth factors, peptides, nucleic acids, and oligonucleotides, together with their related complexes, metabolites, mutations, variants, polymorphisms, modifications, fragments, subunits, degradation products, elements, and other analytes or sample-derived measures. Biomarkers can also include mutated proteins, mutated nucleic acids, variations in copy numbers and/or transcript variants. Biomarkers also encompass non-blood borne factors and non-analyte physiological markers of health status, and/or other factors or markers not measured from samples (e.g., biological samples such as bodily fluids), such as clinical parameters and traditional factors for clinical assessments. Biomarkers can also include any indices that are calculated and/or created mathematically. Biomarkers can also include combinations of any one or more of the foregoing measurements, including temporal trends and differences.

A “clinical assessment,” “clinical datapoint,” or “clinical endpoint,” in the context of the present teachings refers to a measure of disease activity or severity. A clinical assessment can be a score, a value, or a set of values that can be obtained from evaluation of a sample (or population of samples) from a subject or subjects under determined conditions. A clinical assessment can also be predicted by biomarkers and/or other parameters. One of skill in the art will recognize that the clinical assessment for RA, for example, can comprise, without limitation, one or more of the following: DAS, DAS28, DAS28-ESR, DAS28-CRP, HAQ, mHAQ, MDHAQ, physician global assessment VAS, patient global assessment VAS, pain VAS, fatigue VAS, overall VAS, sleep VAS, SDAI, CDAI, RAPID3, RAPID4, RAPIDS, ACR20, ACR50, ACR70, SF-36 (a well-validated measure of general health status), RA MRI score (RAMRIS; or RA MRI scoring system), total Sharp score (TSS), van der Heijde-modified TSS, van der Heijde-modified Sharp score (or Sharp-van der Heijde score (SHS), Larsen score, tender joint count (TJC), and swollen joint count (SJC). A clinical assessment for CVD can comprise, e.g., a Framingham Cardiac Risk Score, blood pressure (diastolic or systolic), heart rate, body mass index, coronary artery calcium, carotid plaque, intima-media thickness, etc.

The term “clinical parameters” in the context of the present teachings encompasses all markers of a subject's health status, including non-sample or non-analyte markers, and/or other characteristics of a subject, such as, without limitation: age; gender/sex; disease duration; race or ethnicity; diastolic and systolic blood pressure; resting heart rate; height; weight; body-mass index (BMI); family history; tender joint count (TJC); swollen joint count (SJC); morning stiffness; arthritis of three or more joint areas; arthritis of hand joints; symmetric arthritis; rheumatoid nodules; radiographic changes and other imaging; CCP status; therapeutic regimen, including but not limited to DMARDs (conventional and/or biologics), steroids, statins, etc.; LDL concentration; HDL concentration; triglyceride concentration; CRP concentration; coronary calcium score; waist circumference; tobacco smoking status; previous history of disease; heart rate; fasting insulin concentration; fasting glucose concentration; diabetes status; and, use of high blood pressure medication. A DMARD is a disease-modifying anti-rheumatic drug.

“Clinical assessment” and “clinical parameter” are not mutually exclusive terms. There may be overlap in members of the two categories; e.g., CRP titer can be used as a clinical assessment of disease activity, and as a measure of the health status of a subject.

The term “mammalian” as used herein includes both humans and non-humans and include but is not limited to humans, non-human primates, canines, felines, murines, bovines, equines, and porcines.

The terms “normal,” “control,” and “healthy,” as used herein, refer generally to a subject or individual who does not have, is not/has not been diagnosed with, or is asymptomatic for a particular disease or disorder. The terms can also refer to a sample obtained from such subject or individual. The disease or disorder under analysis or comparison is determinative of whether the subject is a “control” in that situation. By example, where the level of a particular serum marker is obtained from an individual known to have RA, but who is not diagnosed with and is asymptomatic for CVD, that subject can be the “RA subject.” The level of the marker thus obtained from the RA subject can be compared to the level of that same marker from a subject who is diagnosed with RA, but who is known not to have prevalent CVD and not to be a CVD progressor; i.e., a “normal subject.” Thus, “normal” in this example refers to the subject's CVD status, not RA status.

A “response to treatment” includes a response to an intervention whether biological, chemical, physical, or a combination of the foregoing, intended to sustain or alter the condition of a subject.

A “sample” from a subject can include a single cell or multiple cells or fragments of cells or an aliquot of body fluid, taken from the subject, by means including venipuncture, excretion, ejaculation, massage, biopsy, needle aspirate, lavage sample, scraping, surgical incision or intervention or other means known in the art.

A “subject” is a cell, tissue, or organism, human or non-human, whether in vivo, ex vivo or in vitro, under observation from a mammal, male or female. When we refer to analyzing a subject based on a sample from the subject, we include using blood or other tissue sample from a subject to evaluate the subject's condition; but we also include, for example, using a blood sample itself as the subject to evaluate, for example, the effect of therapy or an agent upon the sample.

A “therapeutic regimen,” “therapy” or “treatment(s),” as described herein, includes all clinical management of a subject and interventions, whether biological, chemical, physical, or a combination thereof, intended to sustain, ameliorate, improve, or otherwise alter the condition of a subject. Treatments include but are not limited to cardiovascular interventions, such as stent placements, angioplasty, coronary bypass surgery, coronary artery grafting, etc., administration of prophylactics or therapeutic compounds (including conventional DMARDs, biologic DMARDs, non-steroidal anti-inflammatory drugs (NSAID's) such as COX-2 selective inhibitors, and corticosteroids; calcium channel blockers, alpha blockers, acetyl salicylic acid, beta blockers, angiotensin-converting-enzyme inhibitors, benazepril, benzthiazide, bumetanide, captopril, chlorothiazide, chlorthalidone, clonidine, enalapril, fosinopril, furosemide, hydralazine, hydralazine and hydrochlorothiazide, hydralazine and hydrochlorothiazide and reserpine, hydrochlorothiazide, hydrochlorothiazide and triamterene, hydroflumethiazide, indapamide, methyclothiazide, methyldopa, metolazone, moexipril, perindopril erbumine, polythiazide, potassium chloride, quinapril, quinethazone, ramipril, torsemide, trandolapril, triamterene, trichlormethiazide, etc.), exercise regimens, physical therapy, dietary modification and/or supplementation, bariatric surgical intervention, administration of pharmaceuticals and/or anti-inflammatories (prescription or over-the-counter), and any other treatments known in the art as efficacious in preventing, delaying the onset of, or ameliorating disease.

A “response to treatment” includes a subject's response to any of the above-described treatments, whether biological, chemical, physical, or a combination of the foregoing. A “treatment course” relates to the dosage, duration, extent, etc. of a particular treatment or therapeutic regimen.

It must be noted that, as used in the specification and the appended claims, the singular forms “a,” “an,” and “the” include plural referents unless the context clearly dictates otherwise.

Methods of the Invention

Analytes, Samples, and Assays

The quantity of one or more analytes of the invention can be indicated as a value. A value can be one or more numerical values resulting from evaluation of a sample (or population of samples) under a condition, e.g., a subject with RA or a subject with RA and a CVD. The values can be obtained, for example, by experimentally obtaining measures from a sample by an assay performed in a laboratory, or alternatively, obtaining a dataset from a service provider such as a laboratory, or from a database or a server on which the dataset has been stored (described in more detail below).

In one embodiment, the quantity of one or more analytes can be one or more numerical values associated with levels of: apoC-III, apoC-III-HP, LpB:C, LpA-II:B:C:D:E, total cholesterol, triglyceride, VLDL-cholesterol, apoA-I, LpA-I, LpA-I:A-II, apoB, TG/HDL-C, and the ratio of apoB/apoA-I, resulting from evaluation of a sample (or population of samples) under a desired condition. Generally, TG/HDL-C and apoB/apoA-I are ratios of the two analytes presented, indicative of a single value. The desired condition can be, for example, the condition of a subject (or population of subjects) before exposure to an agent or in the presence of a disease or in the absence of a disease. Alternatively, or in addition, the desired condition can be the health of a subject or a population of subjects. Alternatively, or in addition, the desired condition can be that associated with a population subjects selected on the basis of at least one of age group, gender, ethnicity, geographic location, diet, medical disorder, clinical indicator, medication, physical activity, body mass, and environmental exposure.

In another embodiment, the invention includes obtaining a sample from a subject, where the sample includes one or more analytes. The sample can be obtained by the subject or by a third party, e.g., a medical professional. Examples of medical professionals include physicians, emergency medical technicians, nurses, first responders, psychologists, medical physics personnel, nurse practitioners, surgeons, dentists, and any other obvious medical professional as would be known to one skilled in the art. The sample can be obtained from any bodily fluid, for example, amniotic fluid, aqueous humor, bile, lymph, breast milk, interstitial fluid, blood, blood plasma, cerumen (earwax), Cowper's fluid (pre-ejaculatory fluid), chyle, chyme, female ejaculate, menses, mucus, saliva, urine, vomit, tears, vaginal lubrication, sweat, serum, semen, sebum, pus, pleural fluid, cerebrospinal fluid, synovial fluid, intracellular fluid, and vitreous humour. In an example, the sample is obtained by a blood draw, where the medical professional draws blood from a subject, such as by a syringe. The bodily fluid can then be tested to determine the value of the analyte. Analytes can include, e.g., biomarkers such as expressed proteins and cell markers, serum proteins, cholesterol, triglycerides, polysaccharides, nucleic acids, genes, proteins, or hormones, or any combination thereof.

Examples of assays for one or more analytes include DNA assays, DNA microarrays, PCR, RT-PCR, Southern blots, Northern blots, ELISAs, flow cytometry, protein assays, Western blots, nephelometry, turbidimetry, chromatography, mass spectrometry, immunoassays, including, by way of example, but not limitation, RIA, immunofluorescence, immunochemiluminescence, immunoelectrochemiluminescence, or competitive immunoassays, immunoprecipitation, and the assays described in the Examples below. The information from the assay can be quantitative and sent to a computer system of the invention. The information can also be qualitative, such as observing patterns or fluorescence, which can be translated into a quantitative measure by a user or automatically by a reader or computer system. In an embodiment, the subject can also provide information other than analyte assay information to a computer system, such as race, height, weight, age, gender, eye color, hair color, family medical history and any other information that may be useful to the user.

Computer Systems and Methods

The systems and methods of the invention can be implemented on various types of computer architectures, such as, for example, on a networked system or in a client-server configuration, or in an application service provider configuration, on a single general purpose computer, or a workstation. The systems and methods can include one or more data signals conveyed via networks (for example, local area network, wide area network, internet, or combinations thereof), fiber optic medium, carrier waves, or wireless networks for communication with one or more data processing devices. The data signals can carry any or all of the data disclosed herein (for example, user input data, the results of the analysis to a user) that is provided to or from a device. It is to be understood that the methods and systems can be implemented in various forms of hardware, software, firmware, special purpose processors, or a combination thereof. The methods and systems can be executed by any machine, device, or platform comprising suitable architecture. It is to be further understood that, because some of the systems and methods are implemented in software, the actual connections between the system components (or the process steps) can differ depending upon the manner in which the method is programmed. Given the teachings herein, one of ordinary skill will be able to contemplate or practice these and similar implementations or configurations of the invention.

In an embodiment, an association of an analyte value from a subject with a cohort can be carried out on a computer system. The computer system can include any or all of the following: a processor, a storage unit, software, firmware, a network communication device, a display, an input, and an output. A computer system can include a server. A server can be a central server that communicates over a network to a plurality of input devices and/or a plurality of output devices. A server can include a storage unit.

Input

In an embodiment, a computer system can include at least one input. Values that indicate a quantity of one or more analytes associated with a subject can be inputted into a computer system in a variety of ways. In another embodiment, information is entered by a user (for example, the subject or a medical professional) into a computer system using an input device. The input device can be a personal computer, a mobile phone or other wireless device, or can be the graphical user interface of a webpage. For example, a webpage programmed in JAVA can include different input boxes to which text can be added by a user, where the string input by the user is then sent to a computer system for processing. The subject can input data in a variety of ways, or using a variety of devices. Data can be automatically obtained and input into a computer from another computer or data entry system. Another method of inputting data to a database is using an input device such as a keyboard, touch screen, trackball, or a mouse for directly entering data into a database.

In another embodiment, information can be sent to a computer system automatically by a device that reads or provides the data values from an analyte assay.

Storage Unit

In an embodiment, a computer system can include at least one storage unit, such as a hard drive or any other device for storing information to be accessed by a processor or external device, wherein the storage unit can include one or more databases including, e.g., data associated with a plurality of subjects associated with a cohort of subjects diagnosed with a medical condition. In an embodiment, a database can store data points corresponding to one or more analytes from one to tens to hundreds to millions of subjects. In another embodiment, a database can include data associated with a first plurality of subjects associated with a first biological cohort of subjects clinically diagnosed with RA and/or CVD. A database can also include data associated with a second plurality of subjects associated with a second biological cohort of subjects not clinically diagnosed with RA and/or CVD. Other pluralities of subjects associated with other biological cohorts of subjects diagnosed with other medical conditions of interest can also be included in a database. A storage unit can also store historical data read from an external database or as input by a user.

In another embodiment, a storage unit stores data received from an input device that is communicating or has communicated with the server. A storage unit can include a plurality of databases. In an embodiment, each of a plurality of databases corresponds to each of a plurality of analytes. In another embodiment, each of a plurality of databases corresponds to each of a plurality of possible medical conditions of a subject. An individual database can also include information for a plurality of possible medical conditions, or one or more analytes, or both. Further, a computer system can comprise multiple servers.

A database can be developed for a medical condition in which relevant information is filtered or obtained over a communication network (for example, the internet) from one or more data sources, such as a public remote database, an internal remote database, and a local database. A public database can include online sources of free data for use by the general public, such as, for example, databases supplied by the U.S. Department of Health and Human Services. For example, an internal database can be a private internal database belonging to particular hospital, or a SMS (Shared Medical system) for providing data. A local database can include, for example, analyte data relating to a medical condition, e.g., a CVD and/or RA. The local database can include data from a clinical trial. It can also include data such as blood test results, subject survey responses, or other items from subjects in a hospital.

Subject data can be stored with a unique identifier for recognition by a processor or a user when desired. In another aspect, the processor or user can conduct a search of stored data by selecting at least one criterion for particular subject data. The particular subject data can then be retrieved.

Processor

In an embodiment, a computer system can include at least one processor. A processor can access data from a storage unit or from an input device to perform a calculation of an output indication from the data. A processor can execute software or computer readable instructions as provided by a user, or provided by the computer system, or server, or other device. The processor can receive subject data directly from an input device, store the subject data in a storage unit, and/or process data. The processor can also receive instructions from a user or a user interface; e.g., a display. The processor can have memory, such as random access memory, as is well known in the art to one of ordinary skill. In one embodiment, an output that is in communication with the processor is provided.

In another embodiment, a processor can determine whether a subject (with or without a medical condition) is associated with a first biological cohort of subjects responsive to an input analyte value differing from a predetermined threshold value (discussed below). Generally, the threshold value can be determined from a database with data associated with the first plurality of subjects associated with the first biological cohort of subjects clinically diagnosed with a medical condition, e.g., RA and/or CVD. In another embodiment, a processor can determine whether a subject (with or without a medical condition) is not associated with the first biological cohort of subjects. In yet another embodiment, a processor can determine whether a subject (with or without a medical condition) is or is not associated with a second or other biological cohort of subjects. Determinations can include use of, e.g., executable code and/or a computer-readable medium.

Systems for determining one or more threshold values for diagnosing a medical condition in a subject can include one or more computing devices associated with a memory and a threshold identification module stored in the memory. Memory is discussed in more detail below. In an embodiment, the threshold identification module can be executable for determining a first value representing a quantity of one or more analytes associated with a first biological cohort of subjects clinically diagnosed with a medical condition. In other embodiments, the threshold identification module can be executable for determining a second value representing a quantity of one or more analytes associated with a second biological cohort of subjects not clinically diagnosed with a medical condition. In other embodiments, the threshold identification module can be executable for determining a first error value which represents a statistical error associated with the first value. In other embodiments, the threshold identification module can be executable for determining a second error value which represents a statistical error associated with the second value. In other embodiments, the threshold identification module can be executable for determining a range of values between the second value minus the second error value and the first value plus the first error value. In yet other embodiments, the threshold identification module can be executable for selecting a threshold value from the range of values.

Systems can also include one or more sample analysis modules stored for analyzing (e.g., comparing) a threshold value against a dataset with data associated with one or more analytes from a subject and generating a score based on the analysis that is indicative of risk of a medical condition in the subject.

Output, Display, and Network Communication Device

After performing a determination, a processor can provide the output, such as from a calculation or association, back to, for example, the input device or storage unit, to another storage unit of the same or different computer system, or to an output device. Output from the processor can be displayed by data display. A data display can be a display screen (for example, a monitor or a screen on a digital device), a print-out, a data signal (for example, a packet), an alarm (for example, a flashing light or a sound), a graphical user interface (GUI; for example, a webpage), or a combination of any of the above. In an embodiment, an output is transmitted over a network (for example, a wireless network) to an output device. The output device can be used by a user to receive the output from the data-processing computer system. After an output has been received by a user, the user can determine a course of action, or can carry out a course of action, such as a medical treatment. In an embodiment, an output device is the same device as the input device. Example output devices include a display, a screen, a computer screen, a telephone, a wireless telephone, a mobile phone, a PDA, a flash memory drive, a light source, a sound generator, a fax machine, a computer, a computer monitor, a printer, an iPOD, and a webpage. In other embodiments, the output device can be in communication with a printer or a display monitor to output the information processed by the server.

In an embodiment, an indication for a subject is provided as an output. In an aspect, an output can be providing an indication that the subject is at increased risk for a medical condition based on an association or lack thereof. In another aspect, an output can be providing an indication that the subject is not at increased risk for a medical condition based on an association or lack thereof. In another aspect, an output can be providing a graphical user interface which displays a representation of a value that indicates a quantity of the one or more analytes associated with the subject and/or a predetermined threshold value.

A client-server, relational database architecture can be used in embodiments of the invention. A client server architecture is a network architecture in which each computer or process on the network is either a client or a server. Server computers are typically computers dedicated to managing disk drives (file servers), printers (print servers), or network traffic (network servers). Client computers include PCs (personal computers) or workstations on which users run applications, as well as example output devices as disclosed herein. Client computers rely on server computers for resources, such as files, devices, and even processing power. In some embodiments of the invention, the server computer handles all of the database functionality. The client computer can have software that handles all the front-end data management and can also receive data input from users.

In an example of the invention, a subject or medical professional enters data variables from an assay for one or more analytes into a webpage. The webpage transmits the data to a computer system or server, where the data is stored and/or processed. For example, the data can be stored in databases of the computer systems. Processors in the computer systems can perform calculations associating the input data with a predetermined threshold value from databases available to the computer systems. The computer systems can then store the output from the calculations in a database and/or communicate the output over a network to an output device, such as a webpage or e-mail. After a user has received an output from the computer system, a user can take a course of medical action according to the output. For example, if the user is a physician and the output demonstrates an association of a subject with a CVD and/or RA differing from a threshold value, the physician can then prescribe a therapy to the subject.

In another example of the invention, a set of users can use a web browser to enter data from an assay measuring one or more analytes into a graphical user interface of a webpage. The webpage is a graphical user interface associated with a front end server, wherein the front end server can communicate with the user's input device (for example, a computer) and a back end server. The front end server can either include or be in communication with a storage device that has a front-end database capable of storing any type of data, for example user account information, user input, and reports to be output to a user. Data from each user (for example, analyte values and/or clinical subject profiles) can then be sent to a back end server capable of manipulating the data to generate a result. For example, the back end server can calculate that there is a high likelihood a subject has a medical condition based on an association of the input data with a predetermined threshold value in a database. The back end server can then send the result back to the front end server where it can be stored in a database or can be used to generate a report. The results can be transmitted from the front end server to an output device (for example, a computer with a web browser) to be delivered to a user. A different user can input the data and receive the data. In an embodiment, results are delivered in a report. In another embodiment, results are delivered directly to an output device that can alert a user of the result of the calculation.

Computer-Readable Storage Medium and Executable Program Code

In other embodiments, the methods and systems can be implemented on different types of devices by executable program code encoded on a computer-readable storage medium. The executable program code can include source code, object code, machine code, or any other stored data that is operable to cause a processing system to perform methods described herein. The executable program code can be provided on many different types of computer-readable media including computer storage mechanisms (for example, CD-ROM, diskette, RAM, flash memory, computer's hard drive, magnetic tape, and holographic storage) that contain instructions (for example, software) for use in execution by a processor to perform the method operations and implement the systems of the invention. In one aspect, data and/or code can be stored and implemented in one or more different types of computer-implemented ways, such as different types of storage devices and programming constructs (for example, data stores, RAM, ROM, Flash memory, flat files, databases, programming data structures, programming variables, IF-THEN (or similar type) statement constructs).

In general, a computer readable medium is provided including computer readable instructions, where the computer readable instructions instruct a processor to execute the methods of the invention. The instructions can operate in a software runtime environment. The computer readable medium can be a storage unit of the invention. It is appreciated by those skilled in the art that computer readable medium can also be any available media that can be accessed by a server, a processor, or a computer. The computer readable medium can be incorporated as part of the computer-based system of the invention, and can be employed for a computer-based assessment of a medical condition.

In one aspect of the invention, a computer readable medium includes computer readable instructions, wherein the instructions when executed associate a medical condition in a subject with a first cohort of subjects clinically diagnosed with a medical condition, the association being based upon data obtained from the subject corresponding to one or more analytes. The computer readable instructions can operate in a software runtime environment of the processor. In an embodiment, a software runtime environment provides commonly used functions and facilities required by the software package. Examples of a software runtime environment include, but are not limited to, computer operating systems, virtual machines or distributed operating systems.

Diseases and Medical Conditions

Diseases and medical conditions of the invention can include rheumatoid arthritis (RA) and cardiovascular diseases (CVDs). CVDs can include atherosclerosis, coronary atherosclerosis, carotid atherosclerosis, hypertension (e.g. pulmonary hypertension, labile hypertension, idiopathic hypertension, low-renin hypertension, salt-sensitive hypertension, low-renin hypertension, thromboembolic pulmonary hypertension, pregnancy-induced hypertension, renovascular hypertension, hypertension-dependent end-stage renal disease, hypertension associated with cardiovascular surgical procedures, and hypertension with left ventricular (LV) hypertrophy), LV diastolic dysfunction, unobstructive coronary heart diseases, myocardial infarctions, cerebral infarctions, peripheral vascular disease, cerebrovascular disease, cerebral ischemia, angina (including chronic, stable, unstable and variant (Prinzmetal) angina pectoris), aneurysm, ischemic heart disease, thrombosis, platelet aggregation, platelet adhesion, smooth muscle cell proliferation, vascular or non-vascular complications associated with the use of medical devices, wounds associated with the use of medical devices, vascular or non-vascular wall damage, peripheral vascular disease, neointimal hyperplasia following percutaneous transluminal coronary angiography, vascular grafting, coronary artery bypass surgery, thromboembolic events, post-angioplasty restenosis, coronary plaque inflammation, hypercholesterolemia, hypertriglyceridemia, embolism, stroke, shock, arrhythmia, atrial fibrillation or atrial flutter, thrombotic occlusion and reclusion cerebrovascular incidents, left ventricular dysfunction, cardiac hypertrophy, and hypertension with left ventricular hypertrophy and/or unobstructive CVD.

In other embodiments, CVD can include conditions associated with oxidative stress, microvascular coronary heart disease, coronary endothelial dysfunction, left ventricular hypertrophy, dyspnea, inflammation, diabetes, and chronic renal failure.

Other CVDs and relevant medical conditions are generally known to one of ordinary skill in the art.

Methods of clinically diagnosing diseases and medical conditions are generally well-known to one of skill in the art. In some embodiments, ultrasound measurements of carotid artery intima-media thickness (IMT) can be used as a measurement of a CVD, e.g. atherosclerosis, and/or as a surrogate endpoint for determining regression or progression of atherosclerotic CVD, especially carotid atherosclerosis. Carotid IMT (CIMT) measures the thickness of carotid artery walls to detect the presence of atherosclerosis (or atherosclerosis burden) and progression of atherosclerosis, and is a surrogate endpoint for evaluating the presence and progression of atherosclerotic CVD. Carotid IMT measurements may be obtained from one or more segments of the carotid artery: in the common carotid, at the bifurcation, or in the internal carotid artery. The IMT of the common carotid artery (CCA), in particular, is useful as an atherosclerosis risk marker. (See, e.g., E. Vicenzini et al., J. Ultrasound Med. 2007, 26:427-432.) Atherosclerosis burden within the artery, as measured by carotid IMT, is related to CVD risk, and has been shown to predict fatal coronary death. See, e.g., J T Salonen and R. Salonen, Arterioscler. Thromb. 1991, 11: 1245-1249; L E Chambless et al., Am. J. Epidemiol. 1997, 146: and, H N Hodis et al., Ann. Intern. Med. 1998, 128: 262-269 (absolute intima-media thickness related to risk for clinical coronary events). Carotid IMT measurements, therefore, can be used to determine atherosclerosis burden in a subject, and changes in IMT can also be used to evaluate changes in atherosclerosis burden, and atherosclerosis progression.

In some embodiments, electron beam tomography or total calcium scores can be used to diagnose a CVD. In other embodiments, coronary artery calcium (CAC) scores, as measured, e.g., by computed tomography (CT), and/or changes in CAC, can be used to diagnose a CVD or as a prognostic indicator of risk of a CVD or progression of CVD. CAC measurements can identify the severity of subclinical atherosclerosis (e.g., coronary atherosclerosis) which is highly correlated with CVD events in general. R. Detrano et al., N. Engl. J. Med. 2008, 358:1336-1345; P. Greenland et al., Circulation 2007, 115:402-426. These and other methods for clinically diagnosing diseases and medical conditions are described in the Examples section below.

Treatment Strategy

Methods of the invention can also include determining a treatment strategy for a subject for delivering/administering a medical treatment or initiating a course of medical action. The determination of treatment strategy can be responsive to an indication provided by a computer system that the subject is at increased risk of a medical condition. Generally, a method of the invention can involve administering a medical treatment based on the treatment strategy or initiating a course of medical action. If a disease has been assessed or diagnosed by a method or system of the invention, a medical professional can evaluate the assessment or diagnosis and deliver a medical treatment according to the evaluation. Medical treatments can include the practice of any method or delivery or use of any product intended to treat a disease or symptoms of the disease. A course of medical action can be determined by a medical professional evaluating the results from a processor of a computer system of the invention. For example, a medical professional can receive output information that informs him or her that a subject has a probability of association with a particular disease of, e.g., 60%, 70%, 80%, 90%, 95% or greater. Based on this probability of association, the medical professional can choose an appropriate course of medical action, such as biopsy, surgery, medical treatment, or no action. In an embodiment, a computer system of the invention can store a plurality of examples of courses of medical action in a database, where processed results can trigger the delivery of one or a plurality of the example courses of action to be output to a user. In an embodiment, a computer system outputs information and an exemplary course of medical action.

In another embodiment, the computer system can initiate an appropriate course of medical action. For example, based on the processed results, the computer system can communicate to a device that can deliver a pharmaceutical to a subject. In another example, the computer system can contact a medical professional based on the results of the processing. In some embodiments, the subject may take medical action. Courses of medical action taken by a subject can take include self-administering a drug, applying an ointment, altering work schedule, altering sleep schedule, resting, altering diet, or scheduling an appointment and/or visiting a medical professional.

Medical professionals can take medical action when alerted by the methods of the invention of the medical condition of a subject. Examples of an alert include, but are not limited to, a sound, a light, a printout, a readout, a display, an alarm, a buzzer, a page, an e-mail, a fax alert, telephonic communication, or a combination thereof. The alert can communicate to the user the raw subject data or the calculated association of the subject data with a cohort in a database, as described above.

The medical action can be based on rules imposed by the medical professional or the computer system. Courses of medical action include, but are not limited to, surgery, prescribing a medication, evaluating mental state, delivering pharmaceuticals, monitoring or observation, biopsy, imaging, and performing assays and other diagnostic tests. In an embodiment, the course of medical action may be inaction. Medical action also includes, but is not limited to, ordering more tests performed on the subject, administering a therapeutic agent, altering the dosage of an administered therapeutic agent, terminating the administration of a therapeutic agent, combining therapies, administering an alternative therapy, placing the subject on a dialysis or heart and lung machine, performing computerized axial tomography (CAT or CT) scan, or performing magnetic resonance imaging (MRI).

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

The practice of the present invention will employ, unless otherwise indicated, conventional methods of protein chemistry, biochemistry, recombinant DNA techniques and pharmacology, within the skill of the art. Such techniques are explained fully in the literature. See, e.g., T. E. Creighton, Proteins: Structures and Molecular Properties (W.H. Freeman and Company, 1993); A. L. Lehninger, Biochemistry (Worth Publishers, Inc., current addition); Sambrook et al., Molecular Cloning: A Laboratory Manual (2nd Edition, 1989); Methods In Enzymology (S. Colowick and N. Kaplan eds., Academic Press, Inc.); Remington's Pharmaceutical Sciences, 18th Edition (Easton, Pa.: Mack Publishing Company, 1990); Carey and Sundberg Advanced Organic Chemistry 3^{rd} Ed. (Plenum Press) Vols. A and B (1992).

Methods

Methods are generally described in Hilpert et al., “Postprandial effect of n-3 polyunsaturated fatty acids on apolipoprotein B-containing lipoproteins and vascular reactivity in type 2 diabetes.,” Am. J. Clin. Nutr. 2007; 85(2):369-76, herein incorporated by reference for all purposes.

Biochemical Assays

Analytes were measured by using conventional methods, as described previously. S G West et al., “Acute effects of monounsaturated fatty acids with and without omega-3 fatty acids on vascular reactivity in individuals with type 2 diabetes,” Diabetologia 2005, 48:113-122. Total apoB and individual apoB-containing subclasses (LpB, LpB:C, LpB:E+LpB:C:E and LpA-II:B:C:D:E) were measured. The quantitative determination of individual apoB-containing subclasses was performed in three separate steps based on sequential immunoprecipitation of whole plasma by polyclonal antisera to apoA-II, apoE, and apoC-III, respectively, as previously described. P. Alaupovic et al., “Separation and identification of apoB-containing lipoprotein particles in normolipidemic subjects and subjects with hyperlipoproteinemias,” Adv. Exp. Med. Biol. 1987, 210:7-14. To simplify this procedure, the LpB:E and LpB:C:E subclasses were measured together. The preparation of antisera was performed according to a previously described procedure. See W J McConathy et al., “Evaluation of immunoaffinity chromatography for isolating human lipoproteins containing apolipoprotein B,” J. Chromatogr. 1985, 342:46-66.

In the first step of this procedure, 100 μL of whole plasma (WP) was diluted with 900 μL phosphate buffered saline containing 0.05% Tween 20, pH 7.4 (Sigma, St. Louis, Mo.), and the concentration of apoB was measured by electroimmunoassay. See M D Curry, A. Gustafson, P. Alaupovic and W J McConathy, “Electroimmunoassay, radioimmunoassay, and radial immunodiffusion assay evaluated for quantification of human apolipoprotein B,” Clin. Chem. 1978, 24:280-286. One hundred microliters of this solution was mixed with polyclonal antiserum to apoA-II (immunoglobulin G (IgG) fraction) and incubated overnight at 4° C. After low-speed centrifugation (10,000 rpm; 4500×g) for 30 min. at 4° C., the supernatant fraction was removed, and its apoB concentration was quantified by electroimmunoassay. The precipitate contained LpA-II:B:C:D:E particles, whereas the supernatant fraction, the anti-apoA-II supernatant (anti-apoA-II-S), contained the LpB, LpB:C, LpB:C:E, and LpB:E subclasses. The concentration of LpA-II:B:C:D:E was calculated as the difference between the concentration of apoB in WP and the concentration of apoB in the anti-apoA-II-S fraction.

In the second step, an aliquot of WP (100 μL) was treated with a mixture of polyclonal antisera to apoA-II and apolipoprotein E (apoE) as described in the first step (IgG fractions). Precipitated lipoprotein subclasses consisted of LpA-II:B:C:D:E, LpB:C:E, and LpB:E. The soluble lipoproteins remaining in the anti-apoA-II/anti-apoE supernatant (anti-apoA-II+anti-apoE-S) were LpB and LpB:C. The concentrations of LpB:C:E and LpB:E particles were calculated as the difference between the concentration of apoB in the anti-apoA-II-S and the concentration of apoB in the anti-apoA-II+anti-apoE-S.

In the last step, the anti-apoA-II+anti-apoE-S (containing the lipoprotein subclasses LpB and LpB:C) was treated with polyclonal antiserum (IgG fraction) to apolipoprotein C-III (apoC-111). The precipitate consisted of the LpB:C subclass, and the supernatant consisted of the LpB subclass. The concentration of the LpB:C subclass was then calculated as the difference between the apoB concentration of the anti-apoA-II+anti-apoE-S, and the apoB concentration of this LpB-containing supernatant.

Alternatively, the anti-apoA-II+anti-apoE-S, which contained the soluble lipoprotein subclasses LpB and LpB:C, was placed on an anti-apoC-III immunosorber and incubated for twelve hours. The fraction unretained on the immunosorber, containing the subclass LpB, was then eluted with a running buffer, and the retained fraction containing LpB:C was eluted with 3M NaSCN. After dialysis and concentration to a smaller volume, both fractions were analyzed for apoB content. The preparation of the anti-apoC-III immunosorber and a detailed description of immunoaffinity chromatography was previously reported. See P. Alaupovic et al., “Effects of lovastatin on ApoA- and ApoB-containing lipoproteins. Families in a subpopulation of subjects participating in the Monitored Atherosclerosis Regression Study (MARS),” Arterioscler. Thromb. 1994, 14:1906-1913.

### Example 1

### Lipid and Lipoprotein Markers in RA Subjects Relative to Control Subjects

The developed methodology for measuring apolipoproteins and apolipoprotein-defined apoA-I and apoB-containing lipoprotein subclasses was applied to a cohort of subjects with RA (26 males and 68 females) recruited from an Oklahoma rheumatology clinic. Age-matched subjects asymptomatic for RA served as controls (29 males and 50 females). Results of this study of lipid and lipoprotein markers in RA and control subjects are presented in Table 1 (HS refers to the supernatant following heparin-precipitation, according to the present methods. Heparin-Mn²⁺ precipitation of apoC-III is described, e.g., in G R Wamick and J J Albers, “A comprehensive evaluation of the heparin-manganese precipitation procedure for estimating high density lipoprotein cholesterol,” J. Lipid Res. 1978, 19:65-76. See also P R Blackett, P. Alaupovic et al., Clin. Chem. 2003, 49(2):303-306.).

TABLE 1

| | | | Multiplicity- |
|---|---|---|---|
| | Subjects | Controls | adjusted |
| Marker | Mean mg/dL (SD) | | p-value |
| total cholesterol | 201.1 ± 46.6 | 186.8 ± 36.8 | 0.042 |
| triglyceride | 163.1 ± 81.7 | 113.1 ± 418 | 1.58E-05 |
| VLDL-cholesterol | 32.0 ± 14.8 | 22.6 ± 8.6 | 1.58E-05 |
| LDL-cholesterol | 109.0 ± 41.3 | 107.4 ± 34.2 | 0.785 |
| HDL-cholesterol | 59.6 ± 17.8 | 53.4 ± 16.9 | 0.422 |
| apoA-I | 133.0 ± 14.5 | 138.7 ± 17.0 | 0.039 |
| LpA-I | 35.7 ± 4.1 | 35.1 ± 4.4 | 0.432 |
| LpA-I:A-II | 97.3 ± 11.6 | 102.1 ± 14.6 | 0.039 |
| apoB | 98.2 ± 15.5 | 89.9 ± 12.8 | 0.001 |
| LpB | 60.8 ± 7.6 | 59.4 ± 7.4 | 0.363 |
| LpB:C | 8.7 ± 4.2 | 10.5 ± 5.6 | 0.039 |
| LpB:E + LpB:C:E | 10.6 ± 5.1 | 10.0 ± 5.5 | 0.520 |
| LpA-II:B:C:D:E | 18.2 ± 8.1 | 10.0 ± 6.0 | 1.06E-10 |
| apoC-III | 12.1 ± 4.8 | 10.2 ± 2.8 | 0.008 |
| apoC-III-HS/-HP ratio | 2.3 ± 2.3 | 2.1 ± 1.3 | 0.595 |
| apoC-III-HS | 6.9 ± 3.5 | 6.4 ± 2.3 | 0.407 |
| apoC-III-HP | 4.7 ± 3.0 | 3.7 ± 1.5 | 0.014 |
| TC/HDL-C | 3.6 ± 1.1 | 3.5 ± 1.1 | 0.785 |
| TG/HDL-C | 3.1 ± 2.1 | 2.2 ± 1.3 | 0.005 |
| apoB/apoA-I | 0.74 ± 0.1 | 0.65 ± 0.1 | 0.0003 |
| age | 60.3 ± 12.8 | 58.1 ± 10.9 | 0.363 |

The entire RA subject cohort displayed significantly higher levels of total cholesterol, triglycerides and VLDL-cholesterol. The levels of apoA-I, but not HDL-cholesterol, were significantly higher in subjects than controls. There was no difference between subjects and controls in the anti-atherogenic LpA-I, but the former had significantly lower levels of LpA-I:A-II than controls. Apolipoprotein B levels were significantly higher in subjects than controls, but this was not reflected in the concentrations of cholesterol-rich LpB subclass or in LDL-cholesterol levels. Among the triglyceride-rich or apoC-III-rich apoB lipoproteins there was no difference in the levels of LpB:E+LpB:C:E between the subjects and controls. The most characteristic abnormality among triglyceride-rich or apoC-III-rich apoB lipoproteins, however, was the very high concentration of atherogenic LpA-II:B:C:D:E subclass in RA subjects in comparison with controls (p-value=1.06E-10). This abnormality is also reflected in significantly increased levels of apoC-III and apoC-III-HP, triglycerides and VLDL-cholesterol; thus, the significantly-increased concentration of apoB is clearly due to increased levels of triglyceride-rich LpA-II:B:C:D:E subclass but not of cholesterol-rich LpB subclass. The significantly higher TG/HDL-cholesterol ratio in RA subjects relative to controls suggests a possible defect in metabolism of triglyceride-rich or apoC-III-rich lipoproteins. Finally, the apoB/apoA-I ratio, considered possibly the best predictor of coronary artery disease in both the general population (G. Walldius et al., “The apoB/apoA-I ratio is better than the cholesterol ratios to estimate the balance between plasma proatherogenic and antiatherogenic lipoproteins and to predict coronary risk,” Clin. Chem. Lab. Med. 2004, 42:1355-1363; A D Sniderman et al., “Errors that result from using the TC/HDL C ratio rather than the apoB/apoA-I ratio to identify the lipoprotein-related risk of vascular disease,” J. Intern. Med. 2006, 259:455-461) and in RA subjects (A G Semb et al., “ApoB/apoA-I is more predictive of AMI in rheumatoid arthritis then LDL-C or NHDL-/HDL-C in the AMORIS study,” Atherosclerosis 2007, Suppl 8:230), was significantly higher in this cohort of RA subjects compared to controls. Lipid and lipoprotein marker levels were then compared between the 25 male and 68 female RA subjects. See Table 2.

TABLE 2

| | | | Bonferroni- |
|---|---|---|---|
| | Males | Females | adjusted |
| Marker | Mean mg/dL (SD) | | p-value |
| total cholesterol | 181.7 ± 41.7 | 208.2 ± 46.7 | 0.565 |
| triglyceride | 165.6 ± 73.0 | 157.3 ± 74.9 | 1.000 |
| VLDL-cholesterol | 33.5 ± 14.5 | 31.5 ± 15.0 | 1.000 |
| LDL-cholesterol | 95.7 ± 38.2 | 113.8 ± 14.0 | 1.000 |
| HDL-cholesterol | 50.5 ± 19.0 | 63.0 ± 1.62 | 0.004 |
| apoA-I | 125.2 ± 13.3 | 136.1 ± 14.0 | 0.038 |
| LpA-I | 33.9 ± 4.1 | 36.4 ± 4.0 | 0.189 |
| LpA-I:A-II | 91.3 ± 10.0 | 99.7 ± 11.4 | 0.040 |
| apoB | 97.3 ± 16.4 | 98.0 ± 14.9 | 1.000 |
| LpB | 59.2 ± 7.8 | 61.0 ± 7.0 | 1.000 |
| LpB:C | 9.9 ± 14.6 | 8.3 ± 4.1 | 1.000 |
| LpB:E + LpB:C:E | 9.7 ± 4.4 | 11.0 ± 5.4 | 1.000 |
| LpA-II:B:C:D:E | 18.6 ± 9.0 | 18.0 ± 7.8 | 1.000 |
| apoC-III | 12.7 ± 5.7 | 11.8 ± 4.3 | 1.000 |
| apoC-III-HS/-HP | 2.1 ± 2.9 | 2.4 ± 2.1 | 0.615 |
| ratio | | | |
| apoC-III-HS | 6.5 ± 5.3 | 7.0 ± 2.7 | 0.993 |
| apoC-III-HP | 5.5 ± 3.1 | 4.4 ± 2.9 | 1.000 |
| TC/HDL-C ratio | 3.9 ± 1.3 | 3.4 ± 1.0 | 1.000 |
| TG/HDL-C ratio | 3.7 ± 2.1 | 2.8 ± 1.8 | 0.830 |
| apoB/apoA-I ratio | 0.8 ± 0.1 | 0.7 ± 0.1 | 1.000 |
| age | 59.0 ± 11.6 | 60.7 ± 13.4 | 1.000 |

As shown in Table 2, female RA subjects tended to show higher levels of TC and LDL-cholesterol, and significantly higher levels of HDL-cholesterol, than male RA subjects RA. As expected, female subjects had significantly higher levels of apoA-I and LpA-I:A-II subclass. This contrasted with male subjects who had slightly higher levels of TG, apoC-III, apoC-III-HP and the triglyceride-rich subclasses LpB:C and LpA-II:B:C:D:E than did female subjects. As a result of lower levels of apoC-III-HS and higher levels of apoC-III-HP, male subjects had a lower apoC-III-HS/apoC-III-HP ratio (2.1 vs. 2.4) than female subjects. The higher concentrations of triglyceride-rich lipoprotein components were also reflected in significantly higher TG/HDL-C ratios in male than female subjects (3.70 vs. 2.80), suggesting that an impairment in the metabolism of triglyceride-rich or apoC-III-rich lipoproteins may be more pronounced in male than in female subjects with RA. It should be emphasized, however, that both male and female subjects had high concentrations of the atherogenic subclass LpA-II:B:C:D:E.

To explore the possible differences in the levels of apoB-containing lipoprotein subclasses and their lipid and apolipoprotein components in male and female subjects with RA, each of these markers was separated into normal and abnormal concentration groups, based on arbitrarily selected cut-off points (27 males, 68 females). Table 3 shows the percent number of males or females with marker levels above (or below) the given cut-off point. As an example, 150 mg/dL was selected as a cut-off point for the level of TG; 60% of the male RA subjects met or exceeded this cut-off point, and 50% of the female subjects did.

TABLE 3

| | Cut-off | | |
|---|---|---|---|
| Marker | (mg/dL) | Males | Females |
| total cholesterol | ≧200 | 32 | 54 |
| triglycerides* | ≧150 | 60 | 50 |
| VLDL-cholesterol | ≧26 | 68 | 59 |
| LDL-cholesterol | ≧130 | 16 | 34 |
| HDL-cholesterol | <45 (M); <50 (F) | 40 | 21 |
| apoB | ≧100 | 44 | 41 |
| LpB | ≧65 | 24 | 34 |
| LpB:C | ≧12.2 | 24 | 21 |
| LpA-II-B:C:D:E | ≧16.0 | 64 | 54 |
| LpB:C + LpA-II:B:C:D:E | ≧28 | 48 | 39 |
| apoC-III | ≧12.5 | 44 | 41 |
| apoC-III-HP | ≧5.0 | 44 | 28 |
| apoC-III-HS/-HP ratio | ≦1.5 | 68 | 44 |
| apoB/apoA-I ratio | ≧0.80 | 48 | 31 |
| TG/HDL-C ratio | ≧3.35 | 48 | 28 |
| TC/HDL-C ratio | >4.45 | 20 | 19 |

As shown in Table 3, relatively the same percent of male and female subjects demonstrated high levels of TG, VLDL-cholesterol, apoB, apoC-III and apoCIII-HP. A higher percentage of female subjects than male had elevated levels of TC and LDL-cholesterol. A slightly higher percentage of females had elevated concentrations of the cholesterol-rich LpB subclass relative to males. In contrast, a slightly higher percentage of male subjects had elevated levels of apoC-III-rich subclasses LpB:C and LpA-II:B:C:D:E. The higher percentage of males demonstrating elevated levels of these two apoC-III-containing lipoprotein subclasses may be due to reduced lipolytic degradation of TG or apoC-III-rich lipoproteins in males compared to females. This potential metabolic abnormality is also evidenced by a higher percentage of male subjects demonstrating a low apoC-III-HS/apoC-III-HP ratio (68% in males had low apoC-III ratio, compared to 44% in females). Note that the apoC-III-HS/-HP ratio has been shown to be a useful surrogate for measuring lipolytic activity. P. Alaupovic, David Rubenstein Memorial Lecture, “The biochemical and clinical significance of the interrelationship between very low density and high density lipoproteins,” Can. J. Biochem. 1981 59:565-579).

An interesting finding was that higher percentages of both male and female RA subjects had elevated levels of TG, VLDL-cholesterol and the apoC-III-rich subclasses LpB:C and LpA-II:B:C:D:E, than had elevated levels of LDL-cholesterol and the cholesterol-rich subclass LpB. As expected, there were fewer female subjects with low levels of HDL-cholesterol (see Table 3) and apoA-I, LpA-I and LpA-IA-II (data not shown) than male subjects.

The apoB/apoA-I ratio is one of the most reliable predictors of CVD in the general population (G. Walldius et al., Clin. Chem. Lab. Med. 2004, 42:1355-1363; A D Sniderman et al., J. Intern. Med. 2006, 259:455-461) and RA (A G Semb et al., Atherosclerosis 2007, Suppl 8:230). In this study, the mean value of the apoB/apoA-I ratio for all males and all females, respectively, in those cases where the value was ≧0.80, was the same in males and females (i.e., a mean of 0.88 for all males where the ratio was ≧0.80, and a mean of 0.89 for all females where the ratio was ≧0.80). Nonetheless, the prevalence of an elevated apoB/apoA-I ratio was higher in male subjects (48%) than in female.

This is the first study providing data on the levels of apoC-III and apolipoprotein-defined apoA- and apoB-containing lipoprotein subclasses in RA. It demonstrates that a relatively high percentage of RA subjects (40-50%) have elevated levels of the atherogenic, apoC-III-rich apoB lipoproteins.

Conclusion

Measurement of nontraditional lipoprotein variables such as individual apolipoprotein-defined apoB-containing lipoprotein subclasses, with and without apoC-III, offers an alternative approach to studying development of atherosclerosis and its consequences in RA subjects. This Example demonstrates that the concentration of the atherogenic, triglyceride- and apoC-III-rich subclass LpA-II:B:C:D:E is significantly higher in RA subjects than in controls. The increased levels of this lipoprotein subclass is reflected in equally higher levels of apoB, TG and VLDL-cholesterol. It is equally important that the concentration of plasma apoC-III is increased in RA subjects relative to controls. In addition, levels of apoC-III bound to apoB-containing lipoproteins (apoC-III-HP) tend to be higher in RA subjects than controls. In contrast, the levels of LDL-cholesterol, considered to be the major marker of atherogenicity, are nearly between RA subjects and controls. The mean levels, as well as percentage of subjects with high levels, of LpA-II:B:C:D:E are the same in male and female RA subjects.

### Example 2

### Markers Predictive of Atherosclerosis Burden in RA Subjects

In this Example, candidate lipid and apolipoprotein markers were assessed for their association with atherosclerosis, using carotid ultrasound to determine carotid artery diameters, or intima-media thickness (IMT), which could then be used as surrogate measures of subclinical atherosclerosis, in RA subjects asymptomatic for atherosclerosis. Certain of the candidate markers were shown to be statistically associated with atherosclerosis as determined by carotid IMT, and thus prognostic of atherosclerosis burden in the RA subject.

For this Example, 145 RA subjects were selected from individuals participating in a longitudinal study of subclinical CVD, the Evaluation of Subclinical Cardiovascular disease And Predictors of Events (ESCAPE) in RA study. Measurements of apoB-containing lipoprotein subclasses were performed by sequential immunoprecipitation with antisera to apoA-II, apoE and apoC-III, according to the methods as described in P. Alaupovic et al., Clin. Chem. 1988, 34:B13. Apolipoproteins A-I, B and C-III were measured by immunoturbidometric procedures, as described by P. Riepponen et al., Scand. J. Clin. Lab. Invest. 1987, 47:739-744. IMT measurements were obtained by carotid ultrasound. Data was derived from the common carotid artery (CCA).

Univariate analyses were performed to assess associations of individual lipoprotein marker levels with IMT. For this purpose a two-sample t-test was used, with Saitterwaite adjustment. The association between lipoprotein markers (or Framingham Cardiac Risk Score “Framingham”) and carotid IMT was then estimated via a Pearson Correlation. The univariate results are shown in Table 4.

TABLE 4

| | ICA | | | | CCA | | |
|---|---|---|---|---|---|---|---|
| | Correlation | N | p-value | | Correlation | N | P |
| Framingham | 0.414 | 135 | 5.94E−07 | Framingham | 0.524 | 135 | 6.63E−11 |
| CAC Score | 0.399 | 144 | 7.21E−07 | CAC Score | 0.353 | 144 | 1.45E−05 |
| TG | 0.044 | 144 | 0.601721 | TG | 0.367 | 145 | 5.61E−06 |
| HDL-C | −0.179 | 137 | 0.035885 | HDL-C | −0.209 | 138 | 0.01381 |
| LpA-I | −0.171 | 144 | 0.039971 | LpA-I | −0.116 | 145 | 0.136 |
| VLDL-C | 0.058 | 143 | 0.49424 | VLDL-C | 0.293 | 144 | 0.000361 |
| LpA-II:B:C:D:E | 0.056 | 144 | 0.50549 | LpA-II:B:C:D:E | 0.260 | 145 | 0.001612 |
| LpB:C + LpB:C:E | 0.071 | 144 | 0.397622 | LpB:C + LpB:C:E | 0.258 | 145 | 0.001764 |
| apoB | −0.027 | 144 | 0.752134 | apoB | 0.302 | 145 | 0.000223 |
| LpB | −0.122 | 144 | 0.143879 | LpB | 0.195 | 145 | 0.018626 |
| LDL-C | −0.042 | 137 | 0.627865 | LDL-C | 0.145 | 138 | 0.08954 |
| TC | −0.086 | 144 | 0.304048 | TC | 0.130 | 145 | 0.11974 |
| apoA-I | −0.071 | 144 | 0.398429 | apoA-I | −0.091 | 145 | 0.277918 |
| LpA-I:A-II | −0.043 | 144 | 0.609585 | LpA-I:A-II | −0.079 | 145 | 0.345844 |

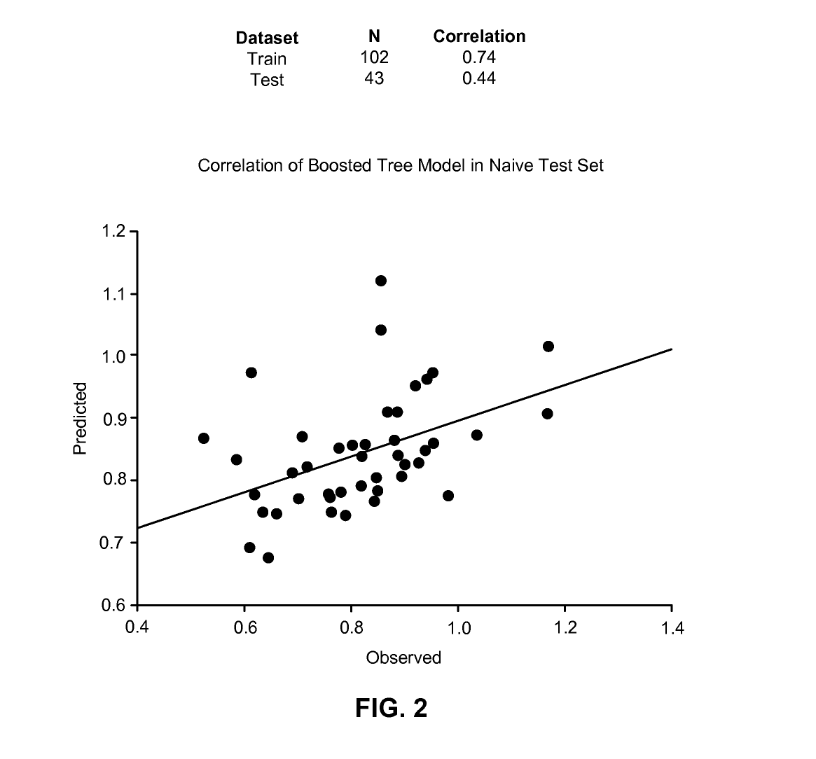

Multivariate predictive models of atherosclerosis burden were built on the data from apoB and apoA-I, apoB-containing lipoprotein subclasses, and the parameters of age and Framingham Cardiac Risk Score, using Boosted Classification and Regression Trees (CART). See FIG. 2 and Appendix (setting out exemplary model script). Table 5 shows the various parameters and their importance in the atherosclerosis burden predictive model. See FIG. 2 for the correlation of Predicted to Observed atherosclerosis burden, as predicted by the multivariate model.

TABLE 5

| Parameter | Importance |
|---|---|
| LpA-II:B:C:D:E | 100 |
| LpB:C + LpB:C:E | 0.92 |
| LpA-I:A-II | 0.91 |
| apoA-I | 0.91 |
| apoB | 0.86 |
| LpB | 0.81 |
| LpB:C | 0.79 |
| age | 0.73 |
| LpA-I | 0.71 |
| Framingham | 0.68 |

Conclusion

Univariate analysis of the data obtained in this Example indicated that total apoB and the apoB-containing lipoprotein subclasses LpB, LpB:C, and LpA-II:B:C:D:E were positively associated with carotid IMT, at a statistically significant level, as were total triglycerides and VLDL-cholesterol. HDL-cholesterol was negatively associated with IMT. Among the apoB-containing lipoprotein subclasses, LpA-II:B:C:D:E demonstrated the strongest association with IMT increase and hence atherosclerosis burden in the RA subject.

When analyzed by multivariate analysis, data from the markers LpB:C, apoB, age, LpA-II:B:C:D:E, and LpB were more important in the multivariate predictive model than the Framingham Cardiac Risk Score in indicating association with carotid IMT. In the multivariate predictive model apoB, LpB:C, LPA-II:B:C:D:E, and age provide more predictive power than Framingham Cardiac Risk Score alone, as regards atherosclerosis burden by IMT. Framingham and the other apolipoproteins add less additional information to the predictive model.

In summary, in RA subjects the specific apoB-containing lipoprotein subclasses provided information beyond the Framingham Cardiac Risk Score for predicting intima-remedial thickness in the common carotid artery (CCA-IMT). ApoC-III containing subclasses were somewhat more important than non-apoC-III containing subclasses in the CCA-IMT prediction model.

### Example 3

### Markers Predictive of CVD Progression in RA Subjects

In this Example, candidate lipid and apolipoprotein complexes (“markers”) were assessed for their association with atherosclerosis, using coronary artery calcium (CAC) as a surrogate measure of subclinical atherosclerosis, in RA subjects asymptomatic for atherosclerosis. Certain of the candidate markers were shown to be statistically associated with atherosclerosis as measured by CAC, and thus prognostic of atherosclerotic-related CVD pathogenesis in the RA subject.

For this Example, 152 RA subjects were selected from the Evaluation of Subclinical Cardiovascular disease And Predictors of Events (ESCAPE) in RA study. CAC was assessed in the subjects by cardiac computed tomography (CT) at two timepoints spanning approximately 3.5 years. Subjects with a change in CAC of greater than or equal to 1 were designated as atherosclerosis progressors (“Progressors”), while subjects with a change in CAC<1, representing net improvement or no change in CAC, were designated as atherosclerosis nonprogressors (“Nonprogressors”). Characteristics of this cohort of 152 RA subjects are shown in Table 6 (IQR=inter quartile range, or 25th-75th percentile; SD=standard deviation).

TABLE 6

| | |
|---|---|
| Variable | Number |

Cohort of 152 RA subjects

| | |
|---|---|
| Progressors | 89 (59%) |
| Nonprogressors | 63 (41%) |
| Mean age in years | 59.2 (SD 8.4) |
| Female | 94 (62%) |
| Hypertension | 78 (52%) |
| RF positive | 89 (59%) |
| Anti-CCP positive | 74 (48%) |
| On Prednisone | 55 (36%) |
| On Plaquenial | 38 (25%) |
| On Methotrexate | 98 (64%) |
| On biologics | 67 (44%) |
| On statins | 25 (16%) |

Entire ESCAPE study population

| | |
|---|---|
| Median RA duration in years | 9 (IQR 5-17) |
| Mean DAS28 score | 3.67 (SD 1.07) |
| Median CRP in mg/L | 2.78 (IQR 1.13-7.69) |
| Mean HAQ score | 0.85 (SD 0.75) |

Serum levels of twelve lipid or apolipoprotein complexes (collectively, “markers”), were measured in each subject at baseline (time Tₒ) by the methods as described above. See Example 3. These markers were total cholesterol (TC), triglyceride (TG), very low-density lipoprotein cholesterol (VLDL), low-density lipoprotein cholesterol (LDL), high-density lipoprotein cholesterol (HDL), apolipoprotein B (apoB), LpA-II:B:C:D:E, LpB:C+LpB:C:E, LpB, LpB:C, apolipoprotein A-I (apoA-I), LpA-I, LpA-I:A-II, apolipoprotein C-III (apoC-III, or CIII), heparin-Mn²⁺ precipitated apoC-III (CIII-HP), apoC-III remaining in the supernatant following heparin-Mn²⁺ precipitation (CIII-HS), and CIII-R. See Methods, above, for a description of the various lipoprotein complexes.

Associations between complex levels and progression status were first analyzed by univariate statistical analysis. Univariate comparisons were made using the two-sample t-test for Nonprogressors (change in CAC≦0, n=63) vs. Progressors (change in CAC>0, n=89). Seven markers were statistically significant, with a p-value of 0.05 or less, in their association with CVD progression in RA subjects, as measured by change in CAC; namely, TG, VLDL, apoB, LpA-II:B:C:D:E, LpB:C, apoC-III and apoC-III-HP. See Table 7. For comparison, the Framingham Cardiac Risk Score's statistical significance in predicting CVD progression is also shown in Table 7.

TABLE 7

| | Nonprogressors | Progressors | |
|---|---|---|---|
| Marker | Mean mg/dL (SD) | Mean mg/dL (SD) | p-value |
| triglyceride | 105.57 (54.82) | 146.07 (99.1) | 0.002 |
| VLDL-C | 21.11 (10.96) | 27.75 (14.32) | 0.002 |
| apoB | 93.22 (15.33) | 100.65 (15.87) | 0.004 |
| LpA-II:B:C:D:E | 14.65 (6.43) | 17.37 (7.92) | 0.021 |
| LpB:C + LpB:C:E | 8.3 (4.41) | 10.28 (4.09) | 0.006 |
| apoC-III | 8.97 (2.99) | 10.38 (4.17) | 0.019 |
| apoC-III-HP | 2.57 (1.02) | 3.1 (1.6) | 0.015 |
| Test | Mean Score (SD) | Mean Score (SD) | p-value |
| Framingham | 0.05 (0.07) | 0.09 (0.07) | 0.002 |

DAS28 and racial composition did not differ significantly between Progressors and Nonprogressors (p-values of 0.53 for DAS 28, 0.419 for racial composition). Sex and age distribution, however, did differ significantly between Progressors and Nonprogressors (p-values of 0.011 for sex and 0.009 for age).

Associations between marker levels and progression status were then analyzed by multivariate statistical analysis. Marker data was Z-transformed (i.e., so the mean of each variable was set to 0 and the SD was 1). Logistic regression was performed on the Z-transformed data for the 152 subjects, and the odds ratios (OR) and p-values determined, OR being a measure of the odds of progression to a CV event versus the odds of no progression. Principal Component Analysis (PCA) was also performed on the significant markers so that collinear markers would contribute maximally to prediction of CV event. The same seven markers were still significant, at p-values less than or equal to 0.05: TG, VLDL, apoB, LpA-II:B:C:D:E, LpB:C, apoC-III and apoC-III-HP (here the results for LpB:C are shown alone, not in conjunction with the subclass LpB:C:E, as above). The results are shown in Table 8.

TABLE 8

| Marker | OR | p-value |
|---|---|---|
| TC | 1.25 | 0.183 |
| TG | 2.17 | 0.004 |
| VLDL-C | 1.83 | 0.004 |
| LDL-C | 1.36 | 0.088 |
| HDL-C | 0.79 | 0.170 |
| apoB | 1.69 | 0.006 |
| LpA-II:B:C:D:E | 1.5 | 0.03 |
| LpB | 1.31 | 0.118 |
| LpB:C | 1.675 | 0.007 |
| apoA-I | 0.812 | 0.215 |
| LpA-I | 0.96 | 0.806 |
| LpA-I:A-II | 0.79 | 0.163 |
| apoC-III | 1.587 | 0.034 |
| apoC-III-HS | 1.322 | 0.132 |
| apoC-III-HP | 1.639 | 0.03 |

Analyses were also performed to control for and/or stratify subjects by clinical variables that could affect apparent associations with atherosclerosis, as represented by change in CAC. When logistic regression was performed on the same data, adjusting for the covariates of interest (i.e., whether subjects were on Prednisone, Plaquenial, Methotrexate, biologics, or statins, as well as hypertension and age), the Adjusted Odds Ratio and associated p-values were analyzed. The same seven markers were still significant, at p-values less than or equal to 0.05: TG, VLDL-cholesterol, apoB, LpA-II:B:C:D:E, LpB:C, apoC-III and apoC-III-HP.

In these analyses, the first principal component was statistically associated with progression both with and without correction for the Framingham Cardiac Risk Score, age and sex. With correction, the association with progression of the principal component demonstrated a p-value of 0.015 and odds ration (OR) of 1.83. Without correction, the p-value was 0.0031, OR 1.86. The first principal component was adjusted for components of the Framingham Cardiac Risk Score to elucidate which components significantly improve prediction. Only sex (male/female) added to the first principal component, significantly resulting in an OR of 2.097 (p-value 0.0011).

Interestingly, all seven of the markers associated with progression contain apoC-III, which is predominantly a triglyceride carrier. Elevations in complexes containing apoC-III were strongly predictive of atherosclerosis progression in RA subjects, suggesting that defects in complex metabolism and/or triglyceride transport contribute to accelerated atherosclerosis in RA, beyond the effects of conventionally assessed lipoproteins such as LDL- and HDL-cholesterol.

### Example 4

### Analysis of Markers in RA Subjects to Indicate Increased Risk of CVD

A cohort of subjects is developed. The cohort consists of male and female RA subjects who have no prior self-reported, physician-diagnosed, clinical cardiovascular event. The study includes three visits to a clinician over a two-year period: the initial visit at (T₀), the second visit a year later (T₁), and the third visit a year after the second visit (T₂). At each visit, an in-depth lipid profile characterization of each RA subject is performed by measuring levels of lipids, apolipoproteins, and apoA-I- and apoB-containing lipoprotein subclasses.

Based on the lipid and lipoprotein marker data collected according to the methods of the present Example, RA subjects are classified on a cross-sectional and longitudinal basis, for the diagnosis and prognosis of CVD. See Table 9. The marker data thus obtained allows for the diagnosis of subclinical atherosclerosis in the RA subject who is otherwise asymptomatic for CVD. It permits early therapeutic intervention, to prevent or reduce the burden of CVD and/or slow or halt its progression. The marker data is prognostic in that it demonstrates to the clinician which RA subjects are or will be CVD progressors. The data also indicates the rate at which progressors will progress in CVD, such that they can be categorized as moderate or high progressors, and a treatment course can be established accordingly.

TABLE 9

| Diagno- | Prognosis (from T₀ to T₁) | | |
|---|---|---|---|
| sis (T₀) | Non-Progressors | Moderate Progressors | High Progressors |
| CVD+ | No progression | Moderate rate of | High rate of |
| | in CVD | progression of CVD | progression in CVD |
| | burden | burden | burden |
| CVD− | No change in | Prognosis of change | Prognosis of change |
| | CVD status | to CVD+ | to CVD+ |
| | | Moderate rate of | High rate of |
| | | progression in CVD | progression in CVD |
| | | burden | |

### Example 5

### A Computer-Implemented Method to Determining Risk of CVD Progression

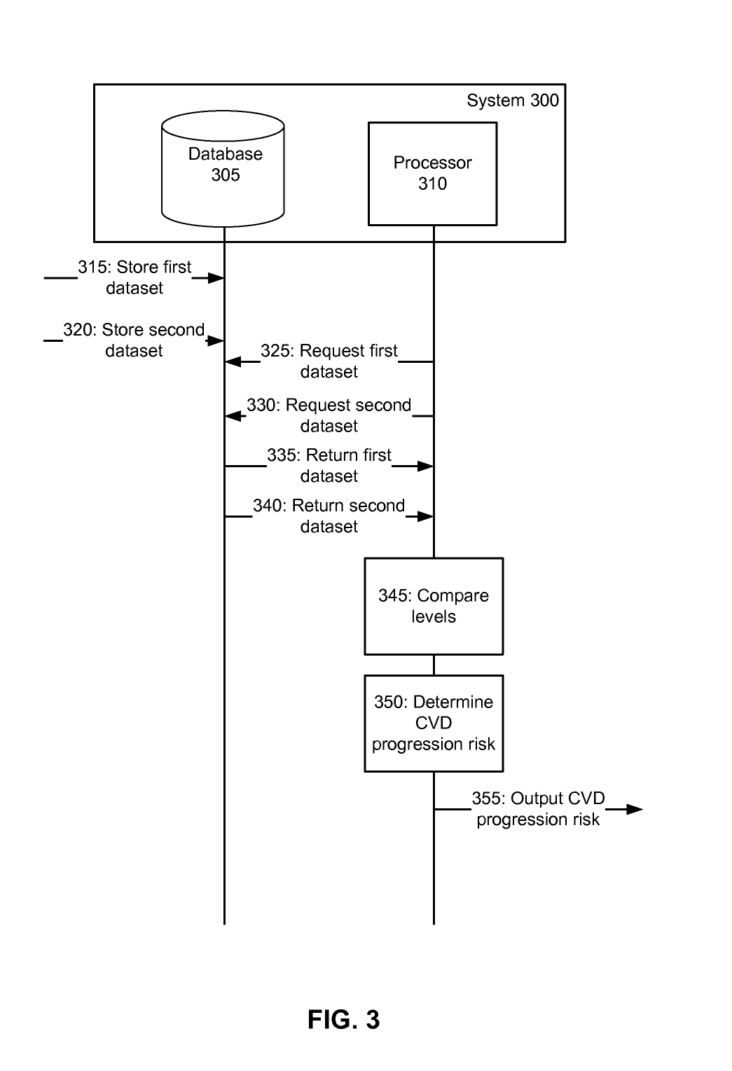

FIG. 3 is a data flow diagram illustrating a computer-implemented method according to one embodiment. The system 300 comprises a database 305 and processor 310. A first dataset is stored 315 in the database 305. The first dataset is associated with a sample obtained from a subject and comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C. A second dataset is also stored 320 in the database 305. The second dataset comprises data indicating a predetermined threshold level of the at least one marker, wherein the threshold level is determined from a database comprising data associated with a plurality of subjects clinically diagnosed with RA and known to be progressors for atherosclerosis.

The processor 310 requests 325 the first dataset which is returned 335 by the database 305. The processor 310 also requests 330 the second dataset which is also returned 340 by the database 305. The processor 310 compares 345 the level of at least one marker the level of the at least one marker of the first dataset with the threshold level of the at least one marker of the second dataset. The processor 310 then determines 350 whether the subject is at risk of CVD progression. If the level of the at least one marker of the first dataset is elevated above the threshold level of the at least one marker of the second dataset the subject is at risk of CVD progression. The processor 310 outputs 355 the subject's risk of CVD progression.

In another embodiment, the dataset stored in the database 305 comprises data associated with a sample obtained from a subject and comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C. The processor 310 determines a CVD risk score from the dataset by applying an interpretation function. The determined CVD risk score provides a quantitative measure of CVD risk in the subject.

Clinical Application

Diagnosis and Prognosis of CVD in the RA Subject

A clinician is presented with a subject diagnosed with RA and asymptomatic for CVD. The clinician submits the RA subject's serum for a lipid-/lipoprotein-marker panel (LMP) for CVD prevalence and risk, according to the methods of the present teachings. The LMP results are then used to diagnose CVD in the RA subject. Where the subject is diagnosed as CVD (+), the LMP is used to categorize the subject's predicted rate of progression as low, moderate, or high.

In the CVD (−) RA subject, the LMP is used alone or in conjunction with the subject's Framingham Cardiac Risk Score to determine CVD risk. Where the Framingham Cardiac Risk Score is used alone and a determination of risk of CVD is made, the LMP verifies or rebuts that prognosis. Likewise, where the Framingham Cardiac Risk Score alone indicates low or no risk of CVD, the LMP verifies or rebuts that prognosis. Alternatively, the LMP is combined with the Framingham Cardiac Risk Score in a multivariate algorithm, to create a more powerful predictor of CVD progression than the Framingham Cardiac Risk Score alone. This multivariate algorithm is then used to determine risk of CVD progression in the RA subject.

In an RA subject established as CVD (+), the LMP results are used to determine whether the subject is a CVD progressor and the predicted rate of progression. The clinician then initiates the appropriate anti-CVD therapeutic intervention.

Monitoring CVD Progression in the RA Subject

Where a clinician is treating an RA subject for CVD, the LMP is used at any timepoint during treatment to evaluate the rate of CVD progression in that subject, and categorize the subject as a low, medium, or high progressor. The clinician then initiates or changes anti-CVD treatment of the subject accordingly. Where an RA subject is initially classified as a high progressor for CVD based on the subject's initial LMP, subsequent LMP results are used to indicate whether there is a change in classification of that subject to moderate, low, or even no CVD progression. The subject's CVD treatment is then adjusted accordingly, and follow-up LMP evaluations are prescribed.

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification are hereby incorporated by reference in their entirety, for all purposes. Accession numbers indicated in this specification are to sequences in the referenced database as of Mar. 9, 2009.

### REFERENCES CITED

1. Lawrence R C, Helmick C G, Arnett F C, Deyo R A, Felson D T, Giannini E H, Heyse J F, Hirsch R, Hochberg M C, Hunder G G, Liang M H, Pillemer S R, Steen V D, Wolfe F: Estimates of the prevalence of arthritis and selected musculoskeletal disorders in the United States. Arthritis Rheum 41:778-799, 1998
2. Wolfe F, Freundlich B, Straus W L: Increase in cardiovascular and cerebrovascular disease prevalence in rheumatoid arthritis. J RheumatoI 30:36-40, 2003.
3. Solomon D H, Karlson E W, Rimm E B, Cannuscio C C, Mandl L A, Manson J E, Stampfer M J, Curhan G C: Cardiovascular morbidity and mortality in women diagnosed with rheumatoid arthritis. Circulation 107:1303-1307, 2003
4. Watson O J, Rhodes T, Guess H A: All-cause mortality and vascular events among patients with rheumatoid arthritis, osteoarthritis, or no arthritis in the UK General Practice Research Database. J. Rheumatol 30:1196-1202, 2003
5. Nicola P J, Maradit-Kremers H, Roger V L, Jacobsen S J, Crowson C S, Ballman K V, Gabriel S E: The risk of congestive heart failure in rheumatoid arthritis: A population-based study over 46 years. Arthritis Rheum 52:412-420, 2005.
6. Maradit-Kremers H, Crowson C S, Nicola P J, Ballman K V, Roger V L, Jacobsen S J, Gabriel S E: Increased unrecognized coronary heart disease and sudden deaths in rheumatoid arthritis: A population-based cohort study. Arthritis Rheum 52:402-411, 2005
7. Reilly P A, Cosh J A, Maddison P J, Rasker J J, Silman A J: Mortality and survival in rheumatoid arthritis: 25 year prospective study of 100 patients. Ann Rheum Dis 49:363-369, 1990
8. Pasceri V, Yeh E T H: A tale of two diseases: atherosclerosis and rheumatoid arthritis. Circulation 100:2124-2126, 1999.
9. Snow M H, Mikuls T R: Rheumatoid arthritis and cardiovascular disease: the role of systemic inflammation and evolving strategies of prevention. Curr Opin RheumatoI 17:234-241, 2005
10. Gazi I F, Boumpas D T, Mikhailidis D P, Ganotakis E S: Clustering of cardiovascular risk factors in rheumatoid arthritis: the rationale for using statins. Clin Exp Rheumatol 25:102-111, 2007
11. Olin-Lewis K, Krauss R M, La Belle M, Blanche P J, Barrett P H R, Wight T N, Chait A: ApoC-1II content of apoB-containing lipoproteins is associated with binding to the vascular proteoglycan biglycan. J Lipid Res 43:1969-1977, 2002
12. Wang C S, McConathy W J, Kloer H U, Alaupovic P: Modulation of lipoprotein lipase activity by apolipoproteins: Effect of apolipoprotein C-1I1. J Clin Invest 75:384-390, 1985.
13. Clayey V, Lestavel-Delattre S, Copin C, Bard J M, Fruchart J-C: Modulation of lipoprotein B binding to the LDL receptor by exogenous lipids and apolipoproteins CI, CII, CIII, and E. Arterioscler Thromb Vase8ioI15:963-971, 1995
14. Blackett P R, Blevins K S, Quintana E, Stoddart M, Wang W, Alaupovic P, Lee E T: ApoC-III bound to apoB-containing lipoproteins increase with insulin resistance in Cherokee Indian youth. Metabolism 54:180-187, 2005
15. Florez H, Mendez A, Casanova-Romero P, Larreal-Urdaneta C, Castillo-Florez S, Lee D, Goldberg R: Increased apolipoprotein C-III levels associated with insulin resistance contribute to dyslipidemia in normoglycemic and diabetic subjects from a triethnic population. Atherosclerosis 188:134-141, 2006
16. Cohn J S, Tremblay M, Bata! R, Jacques H, Rodriguez C, Steiner G, Mauler O, Davignon J: Increased apoC-III production is a characteristic feature of patients with hypertriglyceridemia. Atherosclerosis 177:137-145, 2004
17. Blankenhom D H, Alaupovic P, Wickham E, Chin H P, Azen S P: Prediction of angiographic change in native human coronary arteries and aortocoronary bypass grafts—lipid and nonlipid factors. Circulation 81:470-476, 1990
18. Alaupovic P, Mack W J, Knight-Gibson C, Hodis H N: The role of triglyceride-rich lipoprotein families in the progression of atherosclerotic lesions as determined by sequential coronary angiography from a controlled clinical trial. Arterioscler Thromb Vasc Biol 17:715-722, 1997
19. Hodis H N, Mack W J, Azen S P, Alaupovic P, Pogoda J M, La Bree L, Hemphill L C, Kramsch D M, Blankenhom D H: Triglyceride- and cholesterol-rich lipoproteins have a differential effect on mild to moderate/severe lesion progression as assessed by quantitative coronary angiography in a controlled trial of lovastatin. Circulation 90:42-49, 1994
20. Sacks F M, Alaupovic P, Moye L A, Cole T G, Sussex B, Stampfer M J, Pfeffer M A, Braunwald E: VLDL, apolipoproteins B, CIII, and E, and risk of recurrent coronary events in the cholesterol and recurrent events (CARE) Trial. Circulation 102:1886-1892, 2000
21. Gervaise N, Garrigue M A, Lasfargues G, Lecomte P: Triglycerides, apoC3 and LpB:C3 and cardiovascular risk in type 11 diabetes. Diabetologia 43:703-708, 2000
22. Lee S J, Campos H, Moye L A, Sacks F M: LDL containing apolipoprotein CIII is an independent risk factor for coronary events in diabetic patients. Arterioscler Thromb Vasc Biol 23:853-858, 2003
23. Han T Y, Woo S K, Shin S N, Kang H S: Visceral adiposity and apolipoprotein C-III in apolipoprotein B-containing lipoproteins are independent predictors in determining atherogenic lipid profiles. Ann Nutr Metab 50:31-36, 2006
24. Kawakami. A, Aikawa M, Libby P, Alcaide P, Luscinskas F V V, Sacks F M: Apolipoprotein CIII in apolipoprotein B lipoproteins enhances the adhesion of human monocytic cells to endothelial cells. Circulation 113:691-700, 2006
25. Kawakami A, Aikawa M, Alcaide P, Luscinskas F W, Libby P, Sacks F M: Apolipoprotein C111 induces expression of vascular cell adhesion molecule-1 in vascular endothelial cells and increases adhesion of monocytic cells. Circulation 114:681-687, 2006
26. Kawakami A, Aikawa M, Nitta N, Yoshida M, Libby P, Sacks F M: Apolipoprotein CIII-induced THP-1 cell adhesion to endothelial cells involves pertussis toxin-sensitive G protein- and protein kinase Ca-mediated nuclear factor-kB activation. Arterioscler Thromb Vasc Biol 27:219-225, 2007
27. Alaupovic P: Apolipoprotein composition as the basis for classifying plasma lipoproteins. Characterization of ApoA- and ApoB-containing lipoprotein families. Prog Lipid Res 30:105-138, 1991
28. Alaupovic P: Significance of apolipoproteins for structure, function and classification of plasma lipoproteins. In Methods in Enzymology Plasma Lipoproteins, Part C, Quantitation, 263 ed. Bradley W A, Gianturco S H, Segrest J P, Eds. San Diego, Academic Press, Inc., 1996, p. 32-60
29. Alaupovic P: The concept of apolipoprotein-defined lipoprotein families and its clinical significance. Curr Atheroscler Rep 5:459-467, 2003
30. Koren E, Koscec M, Corder C, Knight-Gibson C, Lee D M, Alaupovic P: Differential atherogenicity of complex apoB-containing lipoprotein particles. Atherosclerosis 109:217-218, 1994
31. Koren E, Corder C, Mueller G, Centurion H, Helium G, Fesmire J, McConathy W J, Alaupovic P: Triglyceride enriched lipoprotein particles correlate with the seventy of coronary artery disease. Atherosclerosis 122:105-115, 1996
32. Solomon D H, Curhan G C, Rimm E B, Cannuscio C C, Karlson E W: Cardiovascular risk factors in women with and without rheumatoid arthritis. Arthritis Rheum 50:3444-3449, 2004
33. van Doomum, McColl G, Wicks I P: Accelerated atherosclerosis: an extraarticular feature of rheumatoid arthritis? Arthritis Rheum 46:862-873, 2002
34. del Rincon I, Freeman G L, Haas R W, O'Leary D H, Escalante A: Relative contribution of cardiovascular risk factors and rheumatoid arthritis clinical manifestations to atherosclerosis. Arthritis Rheum 52:3413-3423, 2005
35. van Leuven S I, Kastelein J J, d'Cruz D P, Hughes G R, Stroes E S: Atherogenesis in rheumatology. Lupus 15:117-121, 2006
36. Aubry M C, Maradit-Kremers H, Reinalda M S, Crowson C S, Edwards W D, Gabriel SE: Differences in atherosclerotic coronary heart disease between subjects with and without rheumatoid arthritis. J Rheumatol 34:937-942, 2007
37. Choi H K, Hermán M A, Seeger J D, Robins J M, Wolfe F: Methotrexate and mortality in patients with rheumatoid arthritis: a prospective study. Lancet 359:1173-1177, 2002
38. Ettinger W U, Klinefetter H F, Kwiterovich P O: Effect of short-term, low-dose corticosteroids on plasma lipoprotein lipids. Atherosclerosis 63:167-172, 1987
39. Boers M, Nurmohamed M T, Doelman C J A, Lard L R, Verhoeven A C, Voskuyl A E, Huizinga T V V J, van de Stadt R J, Dijkmans B A C, van der Linden S: Influence of glucocorticoids and disease activity on total and high density lipoprotein cholesterol in patients with rheumatoid arthritis. Ann Rheum Dis 62:842-845, 2003
40. del Rincon I D, O'Leary D H, Haas R W, Escalante A: Effect of glucocorticoids on the arteries in rheumatoid arthritis. Arthritis Rheum 50:3813-3822, 2004
41. Visvanathan S, Marini J C, Smolen J S, St Clair E W, Pritchard C, Shergy W, Pendley C, Baker D, Bala M, Gathany T, Han J, Wagner C: Changes in biomarkers of inflammation and bone turnover and associations with clinical efficacy following infliximab plus methotrexate therapy in patients with early rheumatoid arthritis. J Rheumatol 34:1465-1474, 2007
42. Dahlqvist S R, Engstrand S, Berglin E, Johnson O: Conversion towards an atherogenic lipid profile in rheumatoid arthritis patients during long-term infliximab therapy. Scand J Rheumatol 35107-111, 2006
43. Dixon W G, Watson K D, Lunt M, Hyrich K L, Silman A J, Simmons D P M: Reduction in the incidence of myocardial infarction in patients with rheumatoid arthritis who respond to anti-tumor necrosis factor alpha therapy: results from the British Society for Rheumatology Biologics Register. Arthritis Rheum 56:2905-2912, 2007
44. Ross R: Atherosclerosis is an inflammatory disease. Am Heart J 138:S419-S420, 1999
45. Libby P, Ridker P M, Maseri A: Inflammation and atherosclerosis. Circulation 105:1135-1143, 2002
46. Pat J K, Pischon T, Ma J, Manson J E, Hankinson S E, Joshipura K, Curhan G C, Rifai N, Cannuscio C C, Stampfer M J, Rimm E B: Inflammatory markers and the risk of coronary heart disease in men and women. N Engl J Med 351:2599-2610, 2004
47. Hurt-Camejo E, Paredes S, Masana L, Camejo G, Sartipy P, Rosengren B, Pedreno J, Vailve J C, Benito P, Wiklund O: Elevated levels of small, low-density lipoprotein with high affinity for arterial matrix components in patients with rheumatoid arthritis—Possible contribution of phospholipase A2 to this atherogenic profile. Arthritis Rheum 44:2761-2767, 2001
48. Solomon D H, Curhan G C, Rimm E B, Cannuscio C C, Karison R V: Cardiovascular risk factors in women with and without rheumatoid arthritis. Arthritis Rheum 50:3444-3449, 2004
49. Vaudo G, Marchesi S. Gerli R, Allegrucci R, Giordano A, Siepi D, Pirro M, Shoenfeld Y, Schillaci G, Marmarino E: Endothelial dysfunction in young patients with rheumatoid arthritis and low disease activity. Ann Rheum Dis 61:31-35, 2004
50. Dessein P H, Joffe B I, Singh S: Biomarkers of endothelial dysfunction, cardiovascular risk factors and atherosclerosis in rheumatoid arthritis. Arthritis Res Ther 7:R634-R643, 2005
51. Park Y B, Lee S K, Lee W K, Suh C H, Lee C W, Lee C H, Song C H, Lee J: Lipid profiles in untreated patients with rheumatoid arthritis. J Rheumatol 26:1701-1704, 1999
52. Park Y B, Choi H K, Kim M Y, Lee W K, Song J, Kim D K, Lee S K: Effects of antirheumatic therapy on serum lipid levels in patients with rheumatoid arthritis-. a prospective study. Am J Med 113:188-193, 2002
53. Yoo W-H: Dyslipoproteinemia in patients with active rheumatoid arthritis: effects of disease activity, sex, and menopausal status on lipid profiles. J Rheumatol 31:1746-1753, 2004
54. Pamuk O N, \acute{Ú}nl\acute{ú}E, Cakir N: Role of insulin resistance in increased frequency of atherosclerosis detected by carotid ultrasonography in rheumatoid arthritis. J Rheumatol 33:2447-2452, 2006
55. Gardner C D, Fortmann S P, Krauss R M: Association of small low-density lipoprotein particles with the incidence of coronary artery disease in men and women. JAMA 276:875-881, 1996
56. Camejo G, Hurt-Camejo E, Wiklund O, Bondjers G: Association of apo B lipoproteins with arterial proteoglycans: Pathological significance and molecular basis. Atherosclerosis 139:205-222, 1998
57. Rantapaa-Dahlqvist S, Milberg-Jonsson S, Dahlén G: Lipoprotein (a), lipids, and lipoproteins in patients with rheumatoid arthritis. Ann Rheum Dis 50:366-368, 1991
58. Alaupovic P: David Rubenstein Memorial Lecture: the biochemical and clinical significance of the interrelationship between very low density and high density lipoproteins. Can J Biochem 59:565-579, 1981
59. Gofman J W, De Latta O, Glazier F, Freeman N K, Lindgren F T, Nichols A V, Strisower B, Tamplin A R: The serum lipoprotein transport system in health, metabolic disorders, atherosclerosis, and coronary heart disease. Plasma 2:413-484, 1954
60. Nichols A V: Human serum lipoproteins and their interrelationships. Adv Blot Med Phys 11109-158, 1967
61. Ewing A M, Freeman N K, Lindgren F T: The analysis of human serum lipoprotein distributions. Adv Lipid Res 3:25-61, 1965
62. Nestel P: High-density lipoprotein turnover. Am Heart J 113:518-521, 1987
63. Packard C J, Shepherd J: Lipoprotein heterogeneity and apolipoprotein B metabolism. Arterioscler Thromb Vasc Biol 17:3542-3556, 1997
64. Alaupovic P: Conceptual development of the classification systems of plasma lipoproteins. Protides Biol Fluids Proc Colloq 19:9-19, 1972
65. Osborne J C, Jr., Brewer H B, Jr.: The plasma lipoproteins. Adv Protein Chem 31:253-337, 1977
66. Fredrickson D S: Phenotyping. On reaching base camp (1950-1975). Circulation 87 Supp 1 11:1-15, 1993
67. Rader D J, Castro G, Zech L A, Fruchart J-C, Brewer H B, Jr.: In vivo metabolism of apolipoprotein A-I on high density lipoprotein particles LpA-1 and LpA-I,A-11. J Lipid Res 32:1849-1859, 1991
68. Fielding C J, Fielding P E. Evidence for a lipoprotein carrier in human plasma catalyzing sterol efflux from cultured fibroblasts and its relationship to lecithin:cholesterol acyltransferase. Proc Natl Acad Sci USA 78:3911-3914, 1981
69. Barkia A, Puchois P, Ghalim N, Torpier G, Barbaras R, Ailhaud G, Fruchart J-C: Differential role of apolipoprotein Al-containing particles in cholesterol efflux from adipose cells. Atherosclerosis 87:135-146, 1991
70. Cheung M C, Wolf A C, Lum K D, Tollefson J H, Albers J J: Distribution and localization of lecithin:cholesterol acyltransferase and cholesteryl ester transfer activity in A-I-containing lipoproteins. J Lipid Res 27:1135-1144, 1986
71. Rinninger F, Brundert M, Jackie S, Kaiser T, Greten H: Selective uptake of low-density lipoprotein-associated cholesteryl esters by human fibroblasts, human HepG2 hepatoma cells and J774 macrophages in culture. Biochim Biophys Acta 1255:141-153, 1995
72. James R W, Pometta D: Postprandial lipemia differentially influences high density lipoprotein subpopulations LpAI and LpAl:All. J Lipid Res 35:1583-1591, 1994
73. Alaupovic P, Knight-Gibson C, Wang C-S, Downs D, Koren E, Brewer N B, Jr., Gregg R E: Isolation and characterization of an apoA-II-containing lipoprotein (LP-A-II:B complex) from plasma very low density lipoproteins of patients with Tangier disease and type V hyperlipoproteinemia. J Lipid Res 329-19, 1991
74. Koren E, Alaupovic P, Lee D M, Dashti N, Kloer H U, Wen G: Selective isolation of human plasma low-density lipoprotein particles containing apolipoproteins B and E by use of a monoclonal antibody to apolipoprotein B. Biochemistry 26:2734-2740, 1987
75. Agnani G, Bard J M, Candelier L, Delattre S, Fruchart J-C, Clayey V: Interaction of LpB, LpB:E, LpB:C-III, and LpB:C-III:E lipoproteins with the low density lipoprotein receptor of HeLa cells. Arterioscler Thromb 11:1021-1029, 1991
76. Puchois P, Kandoussi A, Fievet P, Fourrier J L, Bertrand M, Koren E, Fruchart J-C: Apolipoprotein A-I containing lipoproteins in coronary artery disease. Atherosclerosis 68:35-40, 1987
77. Alaupovic P, Bard J-M, Tavelta M, Shafer D: Identification of apoB-containing lipoprotein families in NIDDM. Diabetes 41(Suppl. 2):18-25, 1992
78. Brown B G, Quiroga C, Morse J, Knight-Gibson C, Alaupovic P, Simpson N, Chait A. Zhao X-Q: Accelerated coronary stenosis progression is associated with the apolipoprotein C-III content of apoB particles among those with diabetes mellitus (Abstract). J. Am. Coll. Cardiol. 43:A488, 2004
79. Koren E, Alaupovic P, Lee D M, Dashti N, Kloer H U, Wen G: Selective isolation of human plasma low-density lipoprotein particles containing apolipoproteins B and E by use of a monoclonal antibody to apolipoprotein B. Biochemistry 26:2734-2740, 1987
80. Curry M D, Alaupovic P, Suenram C A: Determination of apolipoprotein A and its constitutive A-I and A-II polypeptides by separate electroimmunoassays. Clin Chem 22:315-322, 1976
81. Curry M D, Gustafson A, Alaupovic P, McConathy W J: Electroimmunoassay, radioimmunoassay, and radial immunodiffusion assay evaluated for quantification of human apolipoprotein B. Clin Chem 24:280-286, 1978
82. Curry M D, McConathy W J, Fesmire J D, Alaupovic P: Quantitative determination of apolipoproteins C-I and C-II in human plasma by separate electroimmunoassays. Clin Chem 27:543-548, 1981
83. Curry M D, McConathy W J, Fesmire J D, Alaupovic P: Quantitative determination of human apolipoprotein C-111 by electroimmunoassay. Biochim Biophys Ada 617:505-513, 1980
84. Curry M D, McConathy W J, Alaupovic P: Quantitative determination of human apolipoprotein D by electroimmunoassay and radial immunodiffusion. Biochim Biophys Ada 491:232-241, 1977
85. Curry M D, McConathy W J, Alaupovic P, Ledford J D, Popovic M: Determination of human apolipoprotein E by electroimmunoassay. Biochim Biophys Ada 439:413-425, 1976
86. Alaupovic P, Koren E. Immunoaffinity chromatography of plasma lipoprotein particles. In Analyses of Fats, Oils and Lipoproteins. Perkins E G, Ed. Champaign, Ill., American Oil Chemists' Society, 1991, p. 599-622
87. Bekaert E D, Alaupovic P, Knight-Gibson C, Blackett P, Ayrault-Jarrier M: Composition of plasma ApoA-I-containing lipoprotein particles in children and adults. Pediatr Res 29; 315-321, 1991
88. Alaupovic P, Attman P, Knight-Gibson C, Klee H, Weiss L, Samuelsson O: Effect of fluvastatin on apolipoprotein-defined lipoprotein subclasses in patients with chronic renal insufficiency. Kidney Int 69; 1865-1871, 2006
89. Alaupovic P, Tavella M, Fesmire J: Separation and identification of apoB-containing lipoprotein particles in normolipidemic subjects and patients with hyperlipoproteinernias. Adv Exp Med Biol 210:7-14, 1987
90. Hilpert K F, West S G, Kris-Etherton P M, Hecker K D, Simpson N M, Alaupovic P: Postprandial effect of n-3 polyunsaturated fatty acids on apolipoprotein 8-containing lipoproteins and vascular reactivity in type 2 diabetes. Am J Clin Nutr 85:369-376, 2007
91. Alaupovic P, McConathy W J, Fesmire J, Tavella M, Bard J M: Profiles of apolipoproteins and apolipoprotein B-containing lipoprotein particles in dyslipoproteinernias. Cliff Chem 34:813-1327, 1988
92. Maradit-Krerners H, Crowson C S, Nicola P J, Ballrnan K V, Roger V L, Jacobsen S J, Gabriel S E: Increased unrecognized coronary heart disease and sudden deaths in rheumatoid arthritis: A population-based cohort study. Arthritis Rheum 52:402-411, 2005
93. Dessein P H, Tobias M, Veller M G: Metabolic syndrome and subclinical atherosclerosis in rheumatoid arthritis. J Rheumatol 33:2425-2432, 2006
94. Karvounaris S A, Sidiropoulos P I, Papadakis J A, Spanakis E K, Bertsias G K, Kritikos H D, Ganotakis E S, Boumpas D T: Metabolic syndrome is common among middle-to-older aged Mediterranean patients with rheumatoid arthritis and correlates with disease activity: a retrospective, cross-sectional, controlled, study. Ann Rheum Dis 66:28-33, 2006
95. Walldius G, Jungner I, Astveit A H, Holrne I, Furberg C D, Sniderman A D: The apoB/apoA-I ratio is better than the cholesterol ratios to estimate the balance between plasma proatherogenic and antiatherogenic lipoproteins and to predict coronary risk. Clin Chem Lab Med 42:1355-1363, 2004
96. Sniderman A D, Junger I, Holme I, Aastveit A, Walldius G: Errors that result from using the TC/HDL C ratio rather than the apoB/apoA-I ratio to identify the lipoprotein-related risk of vascular disease. J Intern Med 259:455461, 2006
97. Semb A G, Waldius G, Aastveit A, Jungner I, Pedersen T R, Holme I: ApoB/apoA-I is more predictive of AMI in rheumatoid arthritis then LDL-C or NHDL-/HDL-C in the AMORIS study. Atherosclerosis, Suppl 8; 230, 2007
98. Wamick G R, Albers J J: A comprehensive evaluation of the heparin-manganese precipitation procedure for estimating high density lipoprotein cholesterol. J Lipid Res 19:65-76, 1978
99. Friedewald W T, Levy R I, Fredrickson D S: Estimation of the concentration of low-density lipoprotein cholesterol in plasma, without use of the preparative ultracentrifuge. Clin Chem 18:499-502, 1972
100. Riepponen P, Marniemi J, Rautaoja T. Immunoturbidimetric determination of apolipoproteins A-1 and B in serum. Scand J Clin Lab Invest 47:739-744, 1987
101. Lee D M, Downs 0: A quick and large-scale density gradient subfractionation method for low density lipoproteins. J Lipid Res 23:14-27, 1982
102. März W, Trommlitz M, Gross W: Differential turbidimetric assay for subpopulations of lipoproteins containing apolipoprotein A-I. J Clin Chem Clin Biochem 26:573-578, 1988
103. Alaupovic P, Fernandes, J. The serum apolipoprotein profile of patients with glucose-6-phosphatase deficiency. Pediatr Res. 1985 April; 19(4):380-4.
104. McConathy, WJ, Alaupovic, P. Studies of the interaction of Concanavalin A with major density classes of human plasma lipoproteins. Evidence for the specific binding of lipoprotein B in its associated and free forms. FEBS Letters. 41(1):174-178, 1974
105. Tavella M. Alaupovic P, Knight-Gibson C et al: Separation of ApoA- and ApoB-containing lipoproteins of human plasma by affinity chromatography on concanavalin A. Prg Lipid Res 30:181-187, 1991.
106. Cohen J: Statistical power analysis for the behavior sciences (2nd ed). Hillsdale, N.J.: Lawrence Earlbaum Associates
107. Allison P: Logistics Regression Using the SAS System, SAS press, 1999
108. Dozmorov I M, Centola M, Knowlton N, Tans Y H: Mobile classification in microassay experiments. Scan J Immunol 62(Supp11):84-91, 2005
109. Breiman L, Friedman J H, Olshen R A, Stone C J: Classification and Regression Trees. New York: Chapman and Hill, 1984
110. Breiman L: Bagging predictors. Machine Learning 24:123-140, 1996

1. A computer-implemented method for determining whether a rheumatoid arthritis subject is at risk for a cardiovascular disease (CVD) comprising:
a. storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C;
b. storing, in a storage memory, a second dataset, wherein the second dataset comprises data indicating a predetermined threshold level of the at least one marker, wherein the threshold level is determined from a database comprising data associated with a plurality of subjects clinically diagnosed with RA and known to be progressors for atherosclerosis;
c. comparing, by a computer processor, the level of the at least one marker of the first dataset with the threshold level of the at least one marker of the second dataset; and,
d. determining that the subject is at risk of CVD progression when the level of the at least one marker of the first dataset is elevated above the threshold level of the at least one marker of the second dataset.

2. The method of claim 1, wherein the CVD is atherosclerosis.

3. The method of claim 1, wherein the determination of whether the plurality of subjects are progressors for atherosclerosis is based on a positive change in the coronary artery calcium (CAC) measurements of each of the plurality of subjects at two timepoints approximately 2 to 4 years apart.

4. A computer-implemented method for determining whether a rheumatoid arthritis subject is at risk for a cardiovascular disease (CVD) comprising:
a. storing, in a storage memory, a first dataset associated with a sample obtained from the subject, wherein the first dataset comprises data indicating the level of at least one marker selected from the group consisting of triglyceride, VLDL-cholesterol, apoB, LpA-II:B:C:D:E, LpB:C+LpB:C:E, apoC-III, apoC-III-HP, and LpB:C;
b. determining, by a computer processor, a first CVD risk score from the first dataset using an interpretation function, wherein the first CVD risk score provides a quantitative measure of CVD risk in the subject.

5. The method of claim 4, wherein the interpretation function is based on a predictive model.

6. The method of claim 5, wherein the dataset further comprises one or more clinical assessments, one or more clinical parameters, or a combination of one or more clinical assessments and one or more clinical parameters.

7. The method of claim 6, wherein the one or more clinical assessments comprise the Framingham Cardiac Risk Score.

8. The method of claim 5, wherein the one or more clinical parameters is selected from the group consisting of: age, whether the subject is on prednisone, whether the subject is on plaquenial, whether the subject is on methotrexate or another DMARD, whether the subject is on a biologic, hypertension, and whether the subject is on a statin.

9. The method of claim 4, wherein the CVD is atherosclerosis.

10. The method of claim 5, wherein the predictive model is predictive of a positive change in the coronary artery calcium (CAC) measurement of the subject.

11. The method of claim 1, further comprising selecting a CVD treatment regimen based on the determination of whether the subject is at risk for a CVD.

12. A computer-implemented method for determining an atherosclerosis burden in an RA subject comprising:
a. storing, in a storage memory, a first dataset associated with a sample obtained from the subject, wherein the first dataset comprises data indicating the level of at least one marker selected from the group consisting of HDL-cholesterol, LpA-I, triglyceride, apoB, VLDL-C, LpA-II:B:C:D:E, LpB:C, LpB, LpB:E+LpB:C:E, apoA-I, and LpA-I:A-II;
b. storing, in a storage memory, a second dataset, wherein the second dataset comprises data indicating a predetermined threshold level of the at least one marker, wherein the threshold level is determined from a database comprising data associated with a plurality of subjects clinically diagnosed with RA and of a known atherosclerosis burden;
c. comparing, by a computer processor, the level of the at least one marker of the first dataset with the threshold level of the at least one marker of the second dataset; and,
d. determining the level of the atherosclerosis burden in the RA subject when the level of the at least one marker of the first dataset is elevated above the threshold level of the at least one marker of the second dataset.

13. The method of claim 12, wherein the at least one marker comprises LpB:C, apoB, LpA-II:B:C:D:E, LpB, LpB:E+LpB:C:E, apoA-I, LpA-I, or LpA-I:A-II.

14. The method of claim 12, wherein the atherosclerosis burden of the plurality of subjects is based on a carotid artery IMT measurement of each of the plurality of subjects.

15. The method of claim 12, further comprising:
(e) storing, in a storage memory, a third dataset associated with a second sample obtained from the subject, wherein the first sample and the second sample are obtained from the subject at different times;
(f) comparing, by a computer processor, the level of the at least one marker of the first dataset with the level of the at least one marker of the third dataset to determine a change in the levels, wherein the change indicates a change in the atherosclerosis burden in the subject.

16. The method of claim 12, further comprising:
(e) administering a treatment to the subject to reduce the atherosclerosis burden;
(f) storing, in a storage memory, a third dataset associated with a second sample obtained from the subject, wherein the first sample and the second sample are obtained from the subject at different times, and wherein the second sample is obtained from the subject after the treatment is administered to the subject;
(g) comparing, by a computer processor, the level of the at least one marker of the first dataset with the level of the at least one marker of the third dataset to determine a change in the levels, wherein the change indicates a change in the atherosclerosis burden in the subject;
(h) determining the efficacy of the treatment to reduce the atherosclerosis burden in the RA subject based on the change in the levels.

17. The method of claim 1, further comprising:
(e) administering a treatment to the subject to reduce risk of CVD;
(f) storing, in a storage memory, a third dataset associated with a second sample obtained from the subject, wherein the first sample and the second sample are obtained from the subject at different times, and wherein the second sample is obtained from the subject after the treatment is administered to the subject;
(g) comparing, by a computer processor, the level of the at least one marker of the first dataset with the level of the at least one marker of the third dataset to determine a change in the levels, wherein the change indicates a change in CVD risk in the subject;
(h) determining the efficacy of treatment to reduce risk of CVD in the RA subject based on the change in the levels.
